(19) United States
(12) Patent Application Publication
(10) Pub. No.: US 2025/0166352 A1
(43) Pub. Date: May 22, 2025

(54) METHODS AND SYSTEMS OF SENSOR FUSION IN COOPERATIVE PERCEPTION SYSTEMS

(71) Applicant: Currus AI Inc., Orlando, FL (US)

(72) Inventors: Ehsan Emad Marvasti, Orlando, FL (US); Yaser Pourmohammadi Fallah, Oviedo, FL (US); Hussein Alnuweiri, New York, NY (US)

(21) Appl. No.: 18/838,458

(22) PCT Filed: Feb. 15, 2023
(86) PCT No.: PCT/US2023/062670

§ 371 Date: Aug. 14, 2024

Related U.S. Application Data
(60) Provisional application No. 63/310,105, filed on Feb. 15, 2022.

(51) Int. Cl. G06V 10/764; G06T 7/50; G06T 7/62; G06T 7/70; G06V 10/771; G06V 10/80

(52) U.S. Cl. CPC G06V 10/764; G06T 7/50; G06T 7/62; G06T 7/70; G06V 10/771; G06V 10/806; G06T 2207/20081

(57) ABSTRACT

Cooperative perception systems comprise a plurality of imaging sensors that are connected to provide output images to one of one or more machine learning (ML) systems, each ML system is trained to process the output images to yield variational hypotheses. Each of the variational hypotheses comprises one or more objects and, for each of the objects, values for each of a plurality of regressed parameters and variation data indicating uncertainty of the value for each of the plurality of regressed parameters. A processor receives and fuses the hypotheses using the variation data to yield a refined hypothesis. The refined hypothesis may provide an input to a control system for a vehicle, robot or other apparatus.

### REFERENCE TO RELATED APPLICATIONS

This application is a 371 of international application number PCT/US2023/062670 filed Feb. 15, 2023, which claims priority to, and the benefit of, U.S. Provisional Patent Application No. 63/310,105 filed 15 Feb. 2022, which is incorporated by reference herein in its entirety for all purposes.

### TECHNICAL FIELD

This technology relates to cooperative perception systems, and particularly relates to methods of sensor fusion which apply one or more neural networks configured to process inputs from two or more sensors and to fuse outputs of the neural networks. The technology has example application for fusing outputs based on images from 2D and/or 3D imaging sensors to detect and classify objects. The present technology may be used, for example in autonomous or assistive driving systems for land, water and/or airborne vehicles.

### BACKGROUND

Some modern object detection systems utilize a sensor which provides sensor data to a machine learning (ML) system such as a deep neural network (DNN) or convolutional neural network (CNN) in order to produce one or more predictions regarding the sensor data, such as the identification of one or more objects in the view of the sensor. One current area of development relates to integrating the output products of plural sensors to produce more accurate output information. This area may be called “cooperative perception”, “collaborative perception” or “sensor fusion”.

In some systems for cooperative perception, a system might comprise a DNN or CNN for each sensor viewing a scene and have a processor collecting the various conclusions of each DNN/CNN to yield a singular set of hypotheses for the objects present in the scene.

Problems in the field of cooperative perception include improving the accuracy with which objects can be classified and detected and controlling the volume of information to be exchanged.

Despite the large amount of published research in the field of cooperative perception there remains a general need for practical systems and methods for cooperative perception that provide improved accuracy and for practical systems and methods for cooperative perception that can efficiently integrate outputs of sensors of different types.

The foregoing examples of the related art and limitations related thereto are intended to be illustrative and not exclusive. Other limitations of the related art will become apparent to those of skill in the art upon a reading of the specification and a study of the drawings.

### SUMMARY

The present technology has a number of aspects that may be applied individually and in combinations. These include:
systems and methods for sensor fusion in which plural sensor outputs are processed by trained ML models to yield hypotheses which include parameter values and variational information relating to the parameter values and the hypotheses are fused to yield improved hypotheses using the variational information;
systems and methods for sensor fusion in which sensor outputs are processed by trained multi-layer ML models to yield feature maps, the feature maps are fused and processed by a further ML model to yield an improved hypothesis;
cooperative perception systems and methods;
apparatus that includes cooperative perception systems.

The following embodiments and aspects thereof are described and illustrated in conjunction with example systems, tools and methods which are meant to illustrate a variety of ways in which the present technology may be put to use in practical applications and are not limiting in scope. In various embodiments, one or more of the above-described problems have been reduced or eliminated, while other embodiments are directed to other improvements.

One example aspect of the technology provides cooperative perception systems comprising a plurality of imaging sensors. Each of the imaging sensors is connected to provide output images to one of one or more machine learning (ML) systems. The one or more ML systems are trained to process the output images to yield hypotheses. Each of the hypotheses comprises one or more objects and, for each of the objects, values for each of a plurality of regressed parameters and variation data indicating uncertainty of the value for each of the plurality of regressed parameters. In some embodiments the hypotheses are categorical hypotheses that include probabilities that each of the objects is a member of each of a plurality of categories. A processor is connected to receive the hypotheses produced by the ML systems and to fuse the hypotheses using the variation data to yield a fused hypothesis.

In some embodiments the cooperative perception system is provided without sensors, for example to allow existing sensors to be used with the cooperative perception system and/or to allow sensors to be selected and added later.

In some embodiments, each of the ML systems is configured to output a measure of correlation between the regressed parameters. The measure of correlation may, for example, comprise a strength and sign of the correlation. For example, each of the one or more ML systems may be configured to output a precision matrix or covariance matrix that includes the variation data. The precision matrix or covariance matrix may be positive definite and symmetrical. In some embodiments the ML systems are configured such that the precision matrix or covariance matrix is constrained to be positive definite and symmetrical.

In some embodiments the ML systems are configured to classify the one or more objects into each of a plurality of classes and to output the values for each of a plurality of regressed parameters and variation data for each of the plurality of classes for each of the one or more objects.

In some embodiments the variation data comprises an independent-component matrix (e.g. a precision matrix) and an associated rotation angle. In such embodiments the processor may be configured to apply a rotation transformation based on the rotation angle to the independent-component matrix to yield a matrix (e.g. a precision matrix) in which off-diagonal terms indicate strengths and signs of correlations among the regressed parameter values.

In some embodiments the variation data comprises a multivariate probability distribution. The multivariate probability distribution may, for example comprise a multivariate Gaussian (or other symmetric) probability distribution.

In some embodiments the hypotheses comprise multivariate normal probability distributions.

In some embodiments in fusing the hypotheses, the processor is configured to compute products of the distributions of the hypotheses.

In some embodiments the one or more ML system is trained to, for each of the objects, output a likelihood that the object belongs to each of a plurality of classes. The classes may include a residual class. For example, where the cooperative perception system is part of a system for controlling or helping to control land vehicles the classes may for example comprise classes for some or all of pedestrians, cyclists, cars, trucks, animals, debris on a road and a residual class.

The sensor output images do not all need to have the same format. For example, some sensor images may be volumetric images, some sensor images may be 2D images. Sensors may operate according to different modalities (e.g. monocular cameras, stereo cameras, radar, LIDAR, etc. In some embodiments some or all of the sensors output 2D images. In such embodiments the ML systems connected to receive the 2D images may comprise a depth channel and the regressed parameters may include a depth estimate output by the depth channel.

In some embodiments the regressed parameters for the one or more objects comprise localization parameters that estimate a position of the object. The regression parameters may additionally include one or more object size parameters that estimate a size of the object.

In some embodiments the localization parameters for the one or more objects comprise parameters specifying position of the object in three dimensions. For example, the regressed parameters may comprise Cartesian coordinates (e.g. X, Y, Z coordinates) for each of the objects or cylindrical or spherical coordinates for each of the objects.

In some embodiments the regressed parameters of the one or more objects comprise one or more object size parameters that estimate size of the object in two or more dimensions.

In some embodiments the processor is configured to filter the hypotheses to remove any of the hypotheses that have a confidence value below a confidence threshold before fusing the hypotheses. A low confidence value may correspond to a high uncertainty value In some embodiments the confidence value comprises an entropy calculated for the hypothesis.

In some embodiments the processor is configured to cluster the hypotheses, the clustering may comprise: calculating an entropy for each of the hypotheses; selecting a hypothesis for which the entropy is lowest; computing a divergence value between the selected hypothesis and each of the remaining hypotheses; and selecting for fusion the selected hypothesis and those of the remaining hypotheses for which the divergence value is lower than a divergence threshold.

In some embodiments the processor is configured to exclude from the divergence computation some or all of the regressed parameter values for which corresponding values of the variation information indicate an uncertainty exceeding an uncertainty threshold.

In some embodiments the processor is configured to incorporate prior information in the form of a distribution.

In some embodiments a first variational hypothesis and a second variational hypothesis are derived from two-dimensional sensors and the processor is configured to fuse the first variational hypothesis and the second variational hypothesis by:
projecting two or more 2D variational hypotheses into common 3D world coordinates;
identifying a point of closest approach;
estimating a piecewise conical approximation of each of the 2D variational hypotheses at a depth of the point of closest approach; and
fusing the piecewise conical approximation of the 2D variational hypotheses.

Another aspect provides a cooperative perception system. The cooperative perception system comprises a plurality of imaging sensors. Each of the imaging sensors is connected to provide output images to one of one or more first machine learning (ML) systems. The one or more ML systems comprise a plurality of layers and are trained to process the output images to yield hypotheses. Each of the hypotheses comprises: one or more objects and, for each of the objects, values for each of a plurality of regressed parameters and variation data indicating uncertainty of the value for each of the plurality of regressed parameters. The cooperative perception system also includes one or more processors which is connected to: receive feature maps from intermediate layers of the ML systems, the feature maps comprising partially-processed image data of the plurality of imaging sensors; and fuse the feature maps to yield a fused feature map; and process the fused feature map to yield a refined hypothesis. The refined hypotheses comprises: one or more objects and, for each of the objects, values for each of a plurality of regressed parameters. The refined hypothesis is a variational hypothesis in some embodiments. The variational hypothesis may be a categorical variational hypothesis for example.

In some embodiments the feature maps each comprise a plurality of feature kernels, each of the feature kernels associated with a location and comprising a plurality of channels, each of the channels comprising a value. The feature kernels may encode the variation data.

In some embodiments the one or more processors comprises a second ML system configured to receive the fused feature map as input and to output the refined hypothesis. In some embodiments the fused feature map comprises one or more feature tensors, the processor is configured to populate one or more feature tensors with values from one or more sets of fused feature maps and the second ML system is configured to receive the one or more feature tensors as inputs and to output the refined hypothesis.

In some embodiments the sensors comprise a set of first sensors having a first modality and a set of second sensors having a second modality and the one or more processors are configured to: fuse a first set of feature maps corresponding to the first sensors, fuse a second set of feature maps corresponding to the second sensors; and combine the fused first and second sets of feature maps to yield the fused feature map. In some embodiments the first modality is a 2D imaging modality and the second modality is a 3D imaging modality.

In some embodiments the one or more processors are configured to: populate a first feature tensor using the fused set of first feature maps; populate a second feature tensor using the fused set of second feature maps; concatenate the first feature tensor and the second feature tensor to provide a concatenated feature tensor; and process the concatenated feature tensor to provide the refined hypothesis. In some embodiments the first and second feature tensors are each 3D feature tensors.

In some embodiments the sensors comprise a first set of sensors having a first modality and a second set of sensors having a second modality; a first set of feature maps is received by the processor from partially-processed image data of the first set of sensors;

a second set of feature maps is received by the processor from partially-processed image data of the second set of sensors; and the processor is configured to fuse the first set of feature maps and the second set of feature kernels to produce a fused feature map. In some embodiments the first set of sensors comprises 2D sensors and the ML system and processor are configured to process regressed depth anchors in channels of the feature maps. In some embodiments the processor is configured to populate a feature tensor from the fused feature maps and the cooperative perception system comprises a secondary ML system configured to process the feature tensor to calculate a variational hypothesis.

In some embodiments the feature maps comprise categorical multivariate distributions.

In some embodiments the processor is configured to filter the feature maps to remove any of the feature maps that have a confidence value below a confidence threshold before fusing the feature maps. The confidence value may, for example comprise an entropy calculated for the feature maps.

In some embodiments the processor is configured to cluster the feature maps. The clustering may, for example, comprise: calculating an entropy for each of the feature maps; selecting a feature map for which the entropy is lowest; computing a divergence value between the selected feature map and the remaining feature map; and selecting for fusion the selected feature map and those of the remaining feature maps for which the divergence value is lower than a divergence threshold. In some embodiments the processor is configured to exclude from the divergence computation some or all of the regressed parameter values for which corresponding values of the variation information indicate an uncertainty exceeding an uncertainty threshold.

In some embodiments the processor is configured to incorporate prior information in the form of a distribution.

Another aspect of the technology provides methods for performing cooperative perception. The methods comprise: receiving at one or more machine learning (ML) systems a plurality output images produced by a corresponding plurality of sensors and processing the output images to yield a plurality of variational hypotheses. Each output image is processed to provide a corresponding variational hypothesis. Each of the variational hypotheses comprises: one or more objects and, for each of the objects, values for each of a plurality of regressed parameters and variation data indicating uncertainty of the value for each of the plurality of regressed parameters. The variational hypotheses optionally comprise any other feature or combination of features of variational hypotheses as described herein. The method fuses the plurality of sets of variational hypotheses to produce a refined hypothesis. In some embodiments the refined hypothesis provides a control input for controlling an apparatus based on the refined hypotheses. The controlled apparatus may, for example comprise a vehicle, a machine, a robot, a building management system or any other apparatus that includes a control system that can benefit from the input of cooperative perception information.

In some embodiments the variational hypotheses comprise a measure of correlation between the regressed parameters. In some embodiments the measure of correlation comprises a strength and sign of the correlation. In some embodiments the measure of correlation comprises a precision matrix or covariance matrix that includes the variation data.

In some embodiments the precision matrix or covariance matrix is positive definite and symmetrical.

In some embodiments processing the output images to yield a plurality of sets of variational hypotheses comprises classifying the one or more objects into each of a plurality of classes and outputting the values for each of a plurality of regressed parameters and variation data for each of the plurality of classes for each of the one or more objects.

In some embodiments the variation data comprises an independent-component precision matrix and an associated rotation angle. The method may apply a rotation transformation based on the rotation angle to the independent-component precision matrix to yield a precision matrix in which off-diagonal terms indicate strengths and signs of correlations among the regressed parameter values.

In some embodiments the variation data comprises a multivariate probability distribution.

In some embodiments the multivariate probability distributions comprise a multivariate Gaussian (or other symmetrical) probability distribution.

In some embodiments the variational hypotheses comprise multivariate normal probability distributions.

In some embodiments fusing the hypotheses comprises computing products of the distributions of the hypotheses. The products may, for example, comprise inner products of corresponding probability distributions.

In some embodiments the methods comprise, for each of the objects, output a likelihood that the object belongs to each of a plurality of classes.

In some embodiments the methods comprise incorporating depth channels in the ML learning system wherein the regressed parameters include a depth estimate output by the depth channel.

In some embodiments the regressed parameters for the one or more objects comprise localization parameters that estimate a position of the object and/or one or more object size parameters that estimate a size of the object. For example, the regressed parameters may include parameters specifying position of the object in three dimensions (in any suitable coordinate system).

In some embodiments the regressed parameters of the one or more objects comprise one or more object size parameters that estimate size of the object in two or more dimensions.

In some embodiments the methods comprise filtering the hypotheses to remove any of the hypotheses that have a confidence value below a confidence threshold before fusing the hypotheses. For example, the confidence value may comprise an entropy calculated for the hypothesis.

In some embodiments the methods comprise clustering the hypotheses. For example, clustering the hypotheses may comprise: calculating an entropy for each of the hypotheses; selecting a hypothesis for which the entropy is lowest; computing a divergence value between the selected hypothesis and the remaining hypotheses; and selecting for fusion the selected hypothesis and those of the remaining hypotheses for which the divergence value is lower than a divergence threshold.

In some embodiments some or all of the regressed parameter values for which corresponding values of the variation information indicate an uncertainty exceeding an uncertainty threshold are excluded from the divergence calculations.

In some embodiments the methods comprise incorporating prior information in the form of a distribution.

In some embodiments a first variational hypothesis and a second variational hypothesis are derived from two-dimensional sensors and fusing the plurality of variational hypotheses to produce a refined hypothesis comprises: projecting two or more 2D variational hypotheses into common 3D world coordinates; identifying a point of closest approach; estimating a piecewise conical approximation of each of the 2D variational hypotheses at a depth of the point of closest approach; and fusing the piecewise conical approximation of the 2D variational hypotheses.

Another aspect of the technology provides a method for performing cooperative perception. The method comprises: obtaining plural sensor output images from a corresponding plurality of sensors; inputting the plural sensor output images into one or more machine learning (ML) systems to yield a corresponding plurality of feature maps, fusing the feature maps to yield a fused feature map; and processing the fused feature map in a second ML system to output a refined hypothesis.

In some embodiments each of the one or more ML systems comprises a subset of layers of a trained ML system comprising a plurality of layers that has been trained to output variational hypotheses and each of the variational hypotheses comprises: one or more objects and, for each of the objects, values for each of a plurality of regressed parameters and variation data indicating uncertainty of the value for each of the plurality of regressed parameters. The subset of layers includes an input layer of the trained ML system, an intermediate layer of the trained ML system and all layers of the trained ML system between the input layer and the intermediate layer. The feature maps are output at the intermediate layer of the one or more ML system.

In some embodiments each of the feature maps comprises a set of feature kernels wherein each of the feature-kernels comprises: one or more abstractions and, for each of the abstractions, values for each of a plurality of regressed parameters and variation data indicating uncertainty of the value for each of the plurality of regressed parameters. In some embodiments each of the abstractions is associated with a location.

In some embodiments the methods comprise: populating a feature-kernel tensor with the fused feature map; and processing the feature-kernel tensor to produce a set of hypotheses. The hypotheses may be variational hypotheses that may have any features as described herein for variational hypotheses.

In some embodiments fusing the plurality of feature-maps to produce a fused feature-map comprises: registering the plurality of feature maps; and merging the plurality of feature maps.

In some embodiments the sensors comprise sensors belonging to each of a plurality of sensor groups, each of the sensor groups comprising one or more sensors that operate in a respective one of a plurality of distinct imaging modalities, and fusing the plurality of feature maps comprises fusing those of the feature maps derived from the sensor output images from the sensors in each of the sensor groups separately to yield plural fused feature maps.

In some embodiments the methods comprise populating a feature tensor with the fused feature maps. For example, populating the feature tensor may comprise populating each of a plurality of intermediate feature tensors with a respective one of the plural fused feature maps and combining the intermediate feature tensors to yield the feature tensor.

In some embodiments combining the intermediate feature tensors comprises concatenating the intermediate feature tensors.

In some embodiments the refined hypothesis is a variational hypothesis. The variational hypothesis may have any features of variational hypotheses that are described herein. In some embodiments the variational hypothesis is a categorical variational hypothesis.

Another aspect of the technology provides methods for training cooperative perception systems as described herein.

Another aspect of the technology provides apparatus comprising any useful element, combination of elements or sub-combination of elements as described herein.

Another aspect of the technology provides methods comprising any step, act, combination of steps and/or acts or sub-combination of steps and/or acts as described herein.

In addition to the exemplary aspects and embodiments described above, further aspects and embodiments will become apparent by reference to the drawings and by study of the following detailed descriptions.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic illustration of an exemplary cooperative perception system comprising four sensors distributed across two vehicles and one sensor mounted on a fixed pole.

FIG. 2A is graph illustrating a categorical multivariate normal distribution with three classes across one regressed parameter.

FIG. 2B is a graph illustrating a categorical multivariate normal distribution with three classes across one regressed parameter showing a ground truth object in the first object class incorporated as a degenerate multivariable distribution.

FIGS. 2C-2F is a set of graphs illustrating a categorical multivariate normal distribution with three classes across four regressed variables and a ground truth object present in the first object class and incorporated as a degenerate multivariable distribution.

FIG. 2G is a graph illustrating how cells in a single shot detection process may identify a vector for localization of an object within an image space.

FIG. 3 is a flowchart illustrating a process of operating a machine learning system to generate fused variational hypotheses in a cooperative perception system.

FIG. 4 is a flowchart illustrating a process of training a machine learning system to generate fused variational hypotheses in a cooperative perception system.

FIG. 5 is a flowchart illustrating a process of operating a machine learning system to generate fused variational hypotheses from shared feature-kernels in a cooperative perception system.

FIG. 6 is a flowchart illustrating a process of training a machine learning system to generate fused variational hypotheses from shared feature-kernels in a cooperative

FIG. 7 is a flowchart illustrating a cooperative perception system comprising two vehicles with two sensor modalities with a machine learning system implementing a method of feature-sharing to obtain 3D variational hypotheses.

FIG. 8A is a flowchart illustrating a cooperative perception system comprising six vehicles with three sensor modalities with a machine learning system implementing a method of feature-sharing to obtain 3D variational hypotheses using concatenation.

FIG. 8B is a flowchart illustrating a cooperative perception system comprising six vehicles with three sensor modalities with a machine learning system implementing a method of feature-sharing to obtain 3D variational hypotheses with feature-kernels fused probabilistically.

FIG. 9A is a perspective view of a cooperative perception system comprising a 2D sensor and a 3D sensor in which the 2D sensors Gaussian kernel is expanded into the 3D domain and fused with the Gaussian kernel of the 3D sensor to provide a 3D variational hypothesis of the location of an observed car.

FIG. 9B is a perspective view of a cooperative perception system comprising two 3D sensors in which the two Gaussian kernels of the sensors are fused with homography prior to provide a 3D variational hypothesis of the location of an observed car.

FIG. 10A is a perspective view of the extension of a 2D distribution from a 2D sensor projected from its image plane into 3D space using a cylindrical projection.

FIG. 10B is a perspective view of the extension of a 2D distribution from a 2D sensor projected from its image plane into 3D space using a conical projection.

FIG. 10C is a perspective view of the extension of two 2D distribution from two 2D sensor projected from their respective image planes into 3D space using piecewise conical projections.

FIG. 11 is a front view of a cooperative perception system according to an embodiment comprising two drones with three sensors each with two modalities total.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

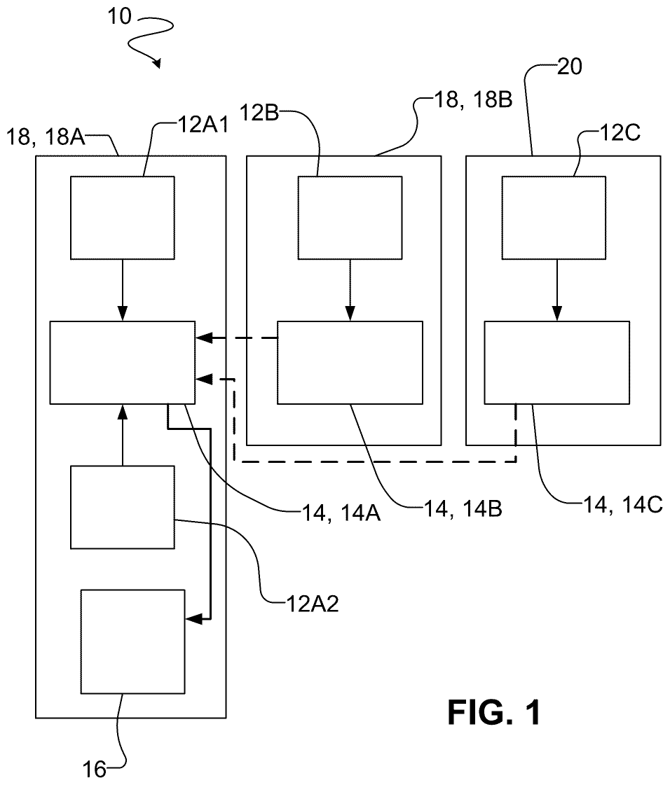

A cooperative perception system 10 enables the integration of measurements of a plurality of sensors 12, as shown in FIG. 1. The plurality of sensors comprises a set of sensors viewing a common scene or environment from multiple positions or vantage points. Individual sensors may be fixed relative to the environment or movable. Two or more sensors may be affixed to a common object. For example, a vehicle may be fitted with plural sensors which may be located at various points on the vehicle's structure to provide different views of the environment.

A cooperative perception system may include sensors of different types and sensors that operate in different modalities. For example, sensors for a cooperative perception system may comprise volumetric sensors (e.g. LIDAR, radar, stereo cameras) which can produce image outputs with 3D image data, and monocular sensors (e.g. cameras which may be, for example monochrome or RGB cameras) which produce image outputs with 2D image data. Other types of sensors and cameras may be used.

In general, it may be assumed that extrinsic camera parameters (e.g. position and pose relative to a known coordinate system) and intrinsic camera parameters (e.g. field-of-view, resolution, focal length, aperture, and) are known for each of sensors 12. For example, However, in some circumstances some extrinsic camera parameters or intrinsic camera parameters may not be known or may have a degree of uncertainty, which may be accounted for in some processes following.

Cooperative perception system 10 comprises one or more machine learning (ML) systems 14. Each ML system 14 is configured (e.g. based on training using machine learning methods) to process output images of at least one of the plurality of sensors 12 to yield hypotheses regarding the contents of the output images.

Each ML system 14 may receive image data from one or more of sensors 12 by a suitable data connection. Data connections may, for example comprise one or more physical (hardwired) connections and wireless connections. Wireless connections may comprise, for example, long range communications (e.g. 5G network communications), short range communications (e.g. Bluetooth™, Near Field Communication (NFC), and Z-Wave™ communications), or a mix of both. In some embodiments, there is a one-to-one correspondence between sensors 12 and ML systems 14. For example, each ML system 14 may be dedicated to process image data from a corresponding one of sensors 12 with each sensor 12 connected to one and only one ML system 14. In various other embodiments there may be more or fewer sensors 12 than ML systems 14. For example, a cooperative perception system 10 may comprise a plurality of vehicles, in which there are a plurality of sensors 12 and one ML system 14 per vehicle.

ML systems 14 are configured to produce hypotheses that each comprise estimations of the presence of objects within the viewed environment, and for each object comprises values for each of a plurality of regressed parameters and variation data indicating uncertainty of the value of each of the plurality of regressed parameters.

Regressed parameters may, for example include some or all of: a category of a detected object, coordinates indicating a position of a detected object in 2 or 3 dimensions, coordinates indicating a pose of a detected object. Other regressed parameters are also possible.

System 10 also includes a processor 16 configured to perform fusion of either intermediate elements of the machine learning system (referred to as feature-kernel sharing and fusion) or fusion of the output products of ML systems 14 system (referred to as variational hypotheses sharing and fusion). The processing elements used to perform fusion may comprise a processor 16 which incorporates processing components that are shared with one or more ML systems 14. For example, a CPU and GPU system configured by software may together operate to provide a ML system 14 and a processor 16. As another example, a neural network or ML system may be configured to implement steps that fuse output products of ML systems 14.

Processors may take any of a wide variety of forms. For example processing functionality may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control system for an apparatus such as a vehicle, robot or the like may implement methods as described herein by executing software instructions in a program memory accessible to the processors.

In the case of feature-kernel sharing and fusion, intermediate products, e.g. feature-kernels, of the machine learning process are extracted from one or more of ML systems 14 and then fused together. The process of sharing and fusion of intermediate products is described in greater detail elsewhere herein in a section on feature-kernel sharing and fusion. The fused intermediate products may be processed to output a hypothesis using a trained ML model 14A.

In the case of sharing and fusion of hypotheses, each ML system 14 processes imaged output by a sensor to yield output hypotheses. The output hypotheses are aggregated and fused to yield a refined hypothesis. The process of sharing and fusion of hypotheses is described in greater detail in the section on variational hypotheses sharing and fusion. The communication of intermediate products or hypotheses by ML systems may be performed using suitable data communication channels as described elsewhere herein. In the figures, transmitting and receiving elements are omitted for clarity.

Cooperative perception system 10 comprises processing elements connected to receive the hypotheses generated by one or more of the ML systems 14. In the embodiments described herein, processor 16 provides these processing elements, but they may be additionally or alternatively implemented as a separate processing unit within system 10. Processor 16 fuses a plurality of the hypotheses predicted by ML systems 14 to generate a refined hypothesis that identifies and provides parameters for one or more objects in the fields of view of the plurality of sensors 12. Processor 16 may use the refined hypotheses to select an action such as controlling operation of a machine, such as a vehicle or a robot. Some examples of uses of a cooperative perception system 10 comprise control of autonomous vehicles, drones, and other robotics. Some of these applications are described in further detail below in a section on applications of cooperative perception systems.

FIG. 1 is a schematic illustration of an example cooperative perception system 10. Two vehicles 18A and 18B (generally and collectively vehicles 18) on a street each carry at least one sensor 12. In this example, vehicle 18A carries two monocular cameras 12A1, 12A2 which are each positioned to view the street setting and vehicle 18B carries a monocular camera 12B that is also positioned to view the street setting. A LIDAR volumetric sensor 12C is mounted on a pole 20 to view the same street setting. ML systems 14A, 14B and 14C are respectively associated with sensors 14A1 and 14A2, sensor 14B and sensor 14C. For example, ML systems 14A, 14B and 14C may be respectively located at vehicle 18A, vehicle 18B and pole 20.

ML systems 14A, 14B, and 14C generate variational hypotheses. The variational hypotheses are registered into a common world coordinate system (e.g. by applying spatial transformations) and fused to yield a refined hypothesis. In system 10 of FIG. 1 the variational hypotheses are registered and fused in processor 16 at vehicle 18A. Data representing the variational hypotheses output by ML systems 14B and 14C may be transferred to vehicle 18A by any suitable data communication channels.

In this example, processor 16 at vehicle 18A registers and fuses the variational hypotheses to produce refined hypotheses. Processor 16 uses the refined hypotheses to control operation of vehicle 18A. For example, processor 16 may cause vehicle 18A to brake and/or take evasive action in response to determining that a location or characteristics of an object in the refined hypothesis indicates a safety risk. As another example, processor 18 may cause vehicle 18A to adjust its speed and direction to maintain a safe relationship to the location of another vehicle provided in the refined hypothesis.

Refined hypotheses may be shared. For example processor 16 may be configured to wirelessly transmit the fused hypotheses to processors 16 in other vehicles (e.g. vehicle 18B). Processor 16 of vehicle 18B may initiate control actions regarding the operation of vehicle 18B based at least in part on the fused hypotheses. In some embodiments, a subset of the information present in refined hypotheses may be shared. For example, processor 16 may be configured to wireless transmit only the estimated position (e.g. the mean vector) and the classification of the objects to processors 16 in other vehicles.

Cooperative perception system 10 according to various embodiments may use fused hypotheses to identify objects within the scene and identify information about the objects including a classification of each object and estimated properties of the object. A processor 16 may used the fused hypotheses, including the information about the objects in the scene, to control a machine and/or to transmit or display a signal. Controlling a machine may comprise operating a vehicle in the scene, e.g. a vehicle that is autonomously controlled and/or has automated driver assist functionality.

### Generation of Variational Hypotheses

According to various embodiments, a ML model 14 is provided at least in part by a neural network, such as a CNN or DNN, that has been trained to produce: values for one or more regressed parameters per identified object, uncertainty estimates of the regressed parameters. ML model 14 may also be trained to produce a representation of the strength and sign of relationships or correlations between the values of different regressed parameters. The a measure of the correlation between regressed parameters may comprise, for example, a covariance matrix or a precision matrix.

In this section, the method of variational hypotheses is explained in the context of processing image output data from monocular sensors. However, the same methods can be extended with appropriate modifications for consideration of depth data and the relationships between depth parameters and other parameters to allow for the processing of 3D image data. The number of regressed parameters may be selected when configuring the ML system. Some modalities of sensors may contain data for parameters that particularly support the inclusion of particular regressed parameters. For example, a 3D sensor may provide 3D data explicitly supporting regressed parameters in X, Y and Z dimensions. However, regressed parameters may still be calculated by a neural network such as ML system 14 that are not explicitly present in sensor data and so the modality of the sensor does not restrict the set of available regressed parameters. Where depth data is incorporated in the original sensor data (e.g. for volumetric sensors) depth and depth related shape data can be calculated with the regressed parameters. In some other embodiments involving 2D sensors, depth may be incorporated as a regressed parameter calculated or inferred in ML system 14.

In some embodiments a machine learning system 14 is configured to deliver output that has a structure according to equation (1).

$$H = [ μ , {Σ}^{- 1} , C ] \qquad ( 1 )$$

In equation (1), u is a mean vector comprising the mean of each of the regressed parameters. The regressed parameters represent values for character properties of an estimated object. Regressed parameters may, for example, comprise one or more of the location of the object (e.g. in terms of coordinates in the image space), rotation, and shape (height, width, and length). Σ⁻¹ is the precision matrix for the regressed parameters corresponding to the mean vector, u. The covariance matrix 2 for the regressed parameters is related to Σ⁻¹ as its inverse. C is the classification probability mass function (PMF) describing the class of the object.

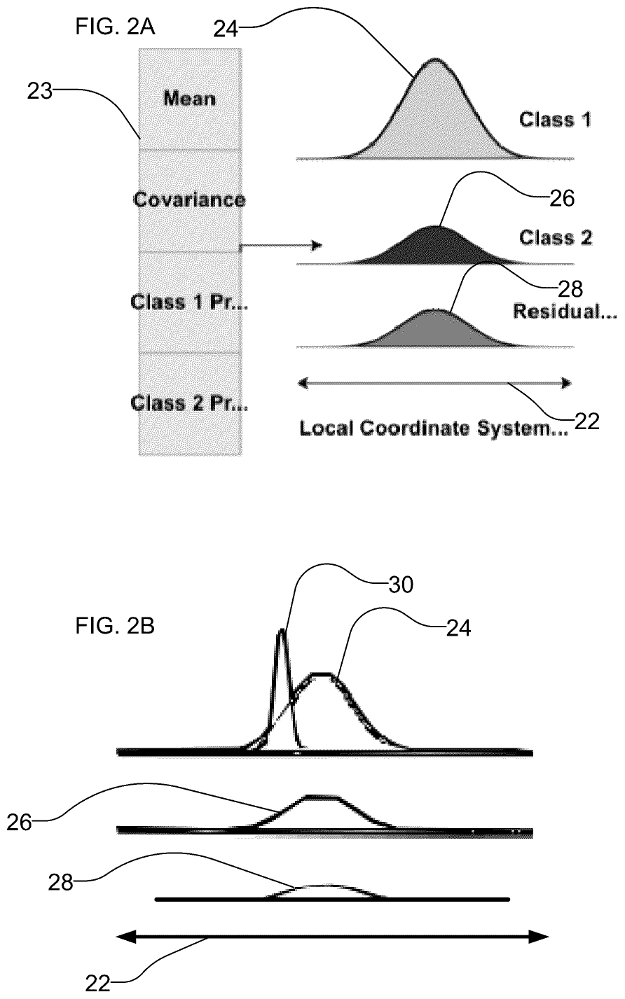

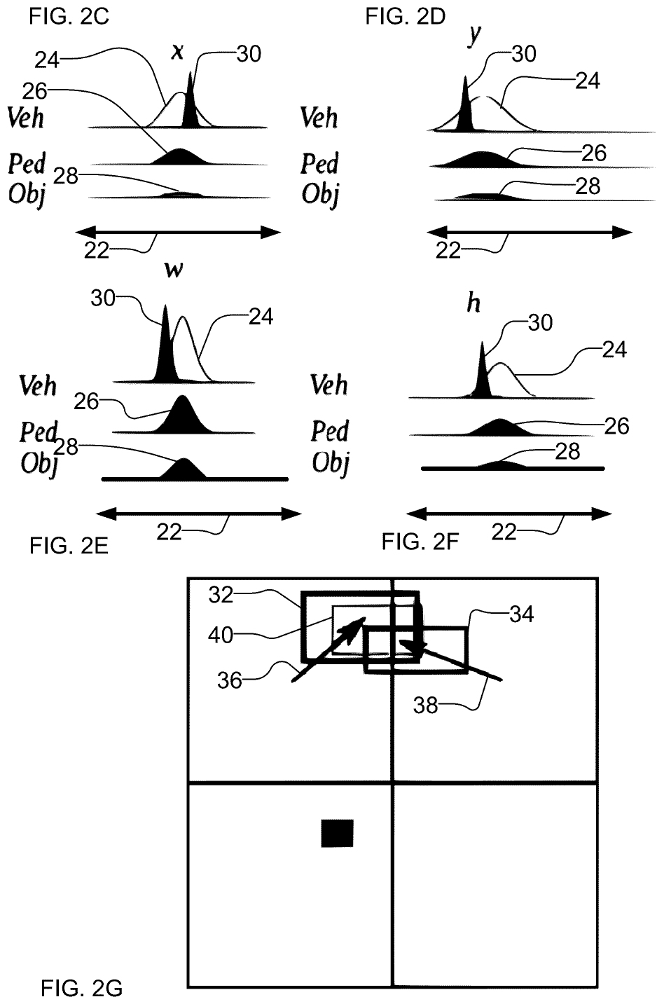

The combination of C and u contains uncertainty information regarding the regressed parameters in the neural network. Σ and Σ⁻¹ are representations of the strength and sign of relationships or correlations between regressed parameters. The combination of μ, Σ⁻¹, and C may define a categorical multi-variate normal distribution, as illustrated in FIG. 2A. Here: “categorical” means that regressed parameters are determined for each of a plurality of categories; “multi-variate” means that the distribution includes probability distributions for plural variables; and “normal” means that the probability distribution takes the form of a Gaussian distribution, i.e. a probability distribution that is symmetric about the mean of the distribution.

By restricting the output of the network to the form presented in equation (1), the training of the network (e.g. by iterating application of the neural network(s) to training data, calculation of an amount of error in the output of the network by a “loss function” and adjustment of network parameters by back propagation until outputs of the network are deemed sufficiently close to the ground truth represented in the training data) causes the neural network to modify the weights, biases, and/or other parameters of the neural network to produce output results that more closely resemble the ground truth information represented in the training data. For clarity, the form given in equation (1) is just one representation of many possible mathematical expressions of the idea that the neural network is trained to produce values for the regressed parameters, uncertainty estimations of the regressed parameters in the neural network and a measure of the correlations between regressed parameters, for each object identified in an image. For example, the output of the neural network could include a probability function other than a PMF and a representation of a correlation between the regressed parameters other than a precision matrix.

In practice, an output in the form of equation (1) can be illustrated as categorical multivariate normal distributions derived from the mean vector, μ, the precision matrix, Σ⁻¹, and the classification probability mass function, C. FIGS. 2A, 2B, and 2C illustrate a categorical multivariate normal distribution for three classes in one dimension. In FIGS. 2A, and 2B only one dimension of regressed parameter is shown. For example, FIGS. 2C-2F represents distributions for regressed parameters as may be identified by a 2D RGB camera. In the examples illustrated in FIGS. 2A through 2F, class 1 represents the object being a vehicle, class 2 represents the object being a pedestrian, and class 3 represents a residual class (the probability that the object is anything else—e.g. not a known object, not an object at all, or not an important object). In FIG. 2A, a categorical multivariate normal distribution with three classes is shown in one dimension represented by axis 22. The categorical multivariate normal distribution is constructed from a mean vector, covariance matrix (or precision matrix), and a probability mass functions per class, shown collectively as block 23. The probability of the object being a car and being constrained within certain coordinates of axis 22 is represented by distribution 24. The probability of the object being a pedestrian and being constrained within certain coordinates of axis 22 is represented by distribution 26. The probability of the object being neither a car nor a pedestrian and being constrained within certain coordinates of axis 22 is represented by distribution 28. The sum of the probabilities represented by 24, 26 and 28 (the sum of their integrals over axis 22) should equal one if the output is a valid categorical multivariate normal distribution.

In the training process, which is described in greater detail elsewhere herein, the outputs of the system are compared against known values, referred to as the ground truth 30. In various embodiments the ground truths are represented as degenerate multivariate normal distributions where the entire probability is limited to a single class of objects. For example, if the ground truth is that the image on which the network is being trained shows a car, then the distribution for the ground truth 30 may be constructed as a degenerate multivariate normal distribution with the entire distribution closely centered around the known position of the car and the remaining classes (pedestrian and residual class) having probabilities of zero, as illustrated in FIGS. 2B and 2C, 2D, 2E, and 2F.

In FIGS. 2C through 2F, categorical multivariate normal distributions for an object being identified by an example cooperative perception system 10 that uses a 2D sensor 12 are shown. The regressed parameters in this case comprise an x-position (FIG. 2C), a y-position (FIG. 2D), a width of the object (FIG. 2E) and a height of the object (FIG. 2F). A ground truth 30 for a known object (a vehicle) is again shown as a degenerate categorical multivariate normal distribution.

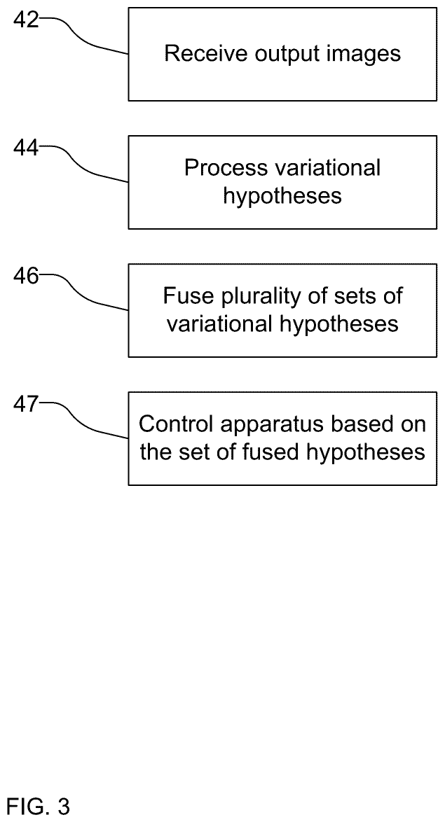

FIG. 3 is a schematic illustration showing the steps of a method that involves an exemplary ML system 14 in a cooperative perception system 10 that has been trained to output variational hypotheses. As a result of training and/or constraints designed into the ML system 14 the variational hypotheses can be made to have a consistent desired form (e.g. the form represented by equation (1), or other forms that contain mathematically comparable and equivalent information).

In step 42, one or more ML systems 14 receives output images from a plurality of sensors 12. In step 44 the one or more ML systems output variational hypotheses. Each of the variational hypotheses is associated with a coordinate space of the sensor 12 from which the output images were produced. In step 46, the processor 16 fuses the sets of variational hypotheses to yield a refined hypothesis. The fusion of the variational hypotheses may, for example be performed by registering the variational hypotheses to a common coordinate system, filtering, clustering and merging the variational hypotheses.

Registering the variational hypotheses may comprise determining a location and pose of each of sensors 12 relative to the common coordinate system. Where the location and pose of a sensor 12 is fixed, the location and pose may be known. In some embodiments a GPS unit or other localization sensor may measure the location and pose of the sensor 12 and output data representing the location and pose of the sensor 12. In some embodiments, the location and pose of the sensor 12 may be determined in part by processing images produced by the sensor 12. From the location and pose of the sensor 12 a transformation may be determined to transform values in the variational hypothesis to be relative to the common coordinate system.

Filtering may be performed to select a subset of the variational hypotheses to fuse. For example, variational hypotheses for which uncertainty values for certain parameters are high (high entropy) may be left out of the fusing.

Clustering may be performed by identifying sets of variational hypotheses whose variables and uncertainties suggest that they describe a common object. For example, clustering may comprise identifying sets of variational hypotheses with low divergence and grouping these sets as identifying an object.

In some embodiments, hypotheses deriving from sensors which have different modalities are fused, this process being referred to as “multi-modal fusion”. Where variational hypotheses from 2D sensors and combined with variational hypotheses from 3D sensors, the hypotheses from the 2D sensors may be extended into 3D space within a common coordinate system in a sub-step prior to merging.

Once variational hypotheses have been fused in step 46, processor 16 can then use these fused hypotheses to control an apparatus based on the information in the hypotheses at step 47.

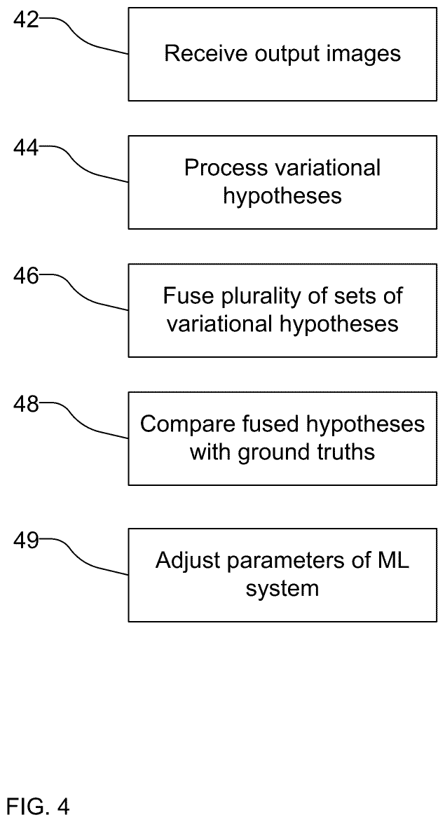

An exemplary method for training of a ML system 14 to operate in a cooperative perception system 10 is illustrated in FIG. 4. The ML system 14 receives output images in step 42, and processes variational hypotheses in step 44. Processor 16 may fused variational hypotheses in step 46 and either or both of the fused and unfused variational hypotheses can be compared to ground truths in step 48, such as the ground truths 30 illustrated in FIGS. 2B-2F. The comparison may performed using a loss function as described elsewhere herein. In step 49, the parameters of the ML system 14 are adjusted based on the comparison of the output products (the unfused or fused variational hypotheses of step 46) and any ground truths known from the sensor images.

### Exemplary Application in a Single Shot Object Detection System

The present technology may be applied in a single shot object detection system which processes arrays which are analogous to images in which each pixel may be called a cell. Each cell corresponds to a location. A number of channels are associated with each cell. Each channel of each cell corresponds to a regressed parameter and carries a value that estimates a value of the regressed parameter. For example, channels may include channels that provide estimates of values of coordinates that indicate the location of an object, channels that provide estimated information regarding the size and shape of the object, and so on. Each cell predicts a vector that indicates an estimated position of the object relative to the location corresponding to the cell, as illustrated in FIG. 2G. FIG. 2G shows two cells 32, 34 which predict vectors 36, 38 showing the relative location of a predicted object 40 relative to the locations of cells 32, 34. The position of the predicted object is estimated by adding the predicted location offset to the location corresponding to the cell. The single-shot networks may also predict a vector for shape parameters. The shape parameters may, for example comprise width and height of the objects, and in some cases may also comprise a length.

The single shot detection system incorporates a variational hypotheses by configuring the cells to include channels that produce uncertainty estimates and a measure of the correlation between the regressed parameters (e.g. cells may also include a set of channels that output values of a precision matrix) in addition to channels that output estimates of the values of the regressed parameters (e.g. values of components of localization and shape vectors.

In an example application of a variational hypothesis method to a single shot object detection system, the output of the localization branch at a cell with indices i and j, denoted as Hₗ is represented by:

$${H}_{l}^{ij} = [ {C}_{ij} , {Δμ}_{ij} , {Σ}_{ij}^{- 1} ] \qquad ( 2 )$$

where Hₗ is the categorical distribution identifying the objectness and the class of the objects. For n classes, the process is iterated across n+1 classes, with the n+1 class representing a residual class. In a case where all objects of interest belong to one of the n classes, the residual class (n+1th class) represents objects that may be present but are not of interest. Δμᵢⱼ is the location and shape mean vector and Σᵢⱼ⁻¹ is the precision matrix of the estimated distribution vector. The outputs of the localization branch at a cell with indices i and j may also be considered to include a rotation θ which is estimated by the network and used to calculate the precision matrix Σᵢⱼ⁻¹.

A single shot detection system that incorporates variational hypotheses may be based on any suitable single shot detection platform. This embodiment is just one example of how variational hypotheses approach might be applied to a specific type of object detection methodology.

### Generalization of the Variational Hypotheses Approach to Object Detection Systems

Any of a wide range of known object detection system, such as but not limited to, YOLO single shot detection systems, R-CNN, Faster R-CNN, RetinaNet, Feature Pyramid Networks, Region of Interest Aligned Networks, and Deformable Part Model object detection systems may be modified to produce outputs that estimate uncertainty of the regressed parameters per class (e.g. in the form of a probability mass function or categorical distribution) in combination with a mean vector and, in some embodiments, a correlation between regressed parameters (e.g. one or both of a precision matrix and a covariance matrix).

A typical object detection system may have a target output that has the general form given by:

$$H = [ μ , C , conf ] \qquad ( 3 )$$

wherein μ represents regressed parameters such as location of the object, rotation, shape (height, width and sometimes length); C represents the categorical distribution representing the probability of the object belonging to a certain class; and conf is a value that represents the confidence of the prediction. Such a system may be modified to produce variational hypotheses by modifying the target output to have the general form shown in Equation (1). This modification may involve adding additional channels to carry values for the precision matrix (Σ⁻¹) for the regressed parameters or the covariance matrix 2, or other representation of the uncertainties of individual regressed parameters.

The machine learning system according to whichever appropriate system is chosen for a given embodiment may be trained under a suitably modified machine learning regime to produce outputs as described in equation (1). Some methods for training a machine learning system to produce outputs as described in equation (1) are described elsewhere herein.

### Estimation of a Precision Matrix

In embodiments that output a measure of the correlations between regressed parameters in the form of a precision matrix or a mathematically equivalent function (such as a covariance matrix), the precision matrix, Σ⁻¹, may be calculated as a step near the last layers of a ML system 14. In some other circumstances, the calculation of a precision matrix might be performed as a post-processing step using the information present in the output of ML system 14. In some embodiments this might be performed by the neural network of ML system 14 in the last layer (the output layer) of the network.

The neural network may be configured to enforce the creation of a valid precision matrix. A valid precision matrix may, for example, be required to be positive definite and symmetric. To enforce the creation of a valid precision matrix, the neural network may be constrained to: estimate a semi-definite independent component precision matrix (for which all off-diagonal terms are zero); apply an activation function to the diagonal elements; and then rotate the independent component precision matrix by an estimated angle θ. The activation function may be constructed to have an output range that is strictly positive (i.e. the diagonal elements cannot have negative values). These steps, including the activation function, may be implemented in nodes of the network in the last layer of ML system 14. An example embodiment illustrating these steps is explained in greater detail below. Other methods could be used to generate a precision matrix or a mathematically equivalent function. Expressing uncertainties in values of regressed parameters as a precision matrix may be beneficial for helping to make the outputs of the network differentiable relative to parameters of the network and for efficient construction of a loss function, both of which can facilitate training of the network.

The neural network may be constrained to generate an independent component precision matrix, \hat{Σ}⁻¹, which is a diagonal matrix where all elements off of the diagonal should be equal to zero, while the values on the diagonal are greater than or equal to zero. To enforce this constraint, an activation function is applied to the diagonal elements that has an output range between zero and positive infinity. Any of various known activation functions have this property including ReLU and the logistic function (sigmoid activation function). To facilitate training, an offset may be added to the output of the activation function so that the minimum bound of the activation function is greater than zero. The offset may be very small, so that the effective range of the activation function is (0, ∞). For example, the ReLU function may be made to incorporate an offset as follows: f(x)={x if x>0; 0.00001 if x≤0}. Including a positive offset in the activation function may reduce instability during training of the neural network, since a zero in the diagonal can cause instability during training.

The precision matrix for the regressed parameters can be calculated from the independent component precision matrix by the application of a rotation. For the description that follow, the rotation is assumed to be in two dimensions, but a rotation for 3D dimensions follows from the same analogous approach. In the two-dimensional approach, the neural network estimates a parameter e representing the estimated angle for rotation required to produce the precision matrix from the independent component matrix. In the 3D case, the neural network would estimate a combination of up to three angular parameters (roll, yaw, and pitch) by which to rotate the independent component precision matrix. In an arbitrary dimensionality of precision matrix, the neural network will generate angles sufficient for the dimensionality of the precision matrix.

The determination of the appropriate angles can be performed using any of various activation functions. Some preferred activation functions are bounded functions. In an example embodiment, the activation function used is the sigmoid function, producing equation (4). The neural network can apply the angle derived from equation (4) to the independent component precision matrix using a rotation matrix R to produce an estimated precision matrix, as shown in equation (5).

$$θ = 180 * sigmoid ( x ) \qquad ( 4 )$$

$${Σ}^{- 1} = R {\hat{Σ}}^{- 1} {R}^{T} \qquad ( 5 )$$

A precision matrix derived by this approach is forced to be positive definite and symmetric because the independent component precision matrix is constructed and activated to be positive definite and symmetric, and the applied rotation preserves those characteristics. Additionally, the steps described here are differentiable, so they are suitable for the application of the loss function and the training of the neural network.

In some embodiments, other methods for calculation of a precision matrix may be implemented. For example, the neural network may be trained to predict a precision matrix directly. Modified forms of activation functions as previously described may be applied to the predicted precision matrix to enforce that it meets the positive definite and symmetric criteria. In some embodiments, a neural network is configured to output a structure that is mathematically similar to a precision matrix or otherwise derived to serve a similar purpose. For example, one or more final layers of a neural network may be configured to output a covariance matrix.

### Training a Variational Hypotheses Machine Learning System

In the variational hypotheses approaches described herein, the target output of the neural networks is an estimation of the uncertainty of the regressed parameters per class (e.g. in the form of a probability mass function or categorical distribution) in combination with a mean vector and, in some embodiments, a measure of correlations between regressed parameters (e.g. one or both of a precision matrix and a covariance matrix). It may be useful to train the network against ground truth data constructed in a corresponding form.

The basic principles and approaches for training neural networks are well understood to those of skill in the art and are extensively described in the literature including textbooks such as Michael A. Nielsen, Neural Networks and Deep Learning, Determination Press, 2015 and Charu C. Aggarwal, Neural Networks and Deep Learning, Springer Cham, 2018 https://doi.org/10.1007/978-3-319-94463-0, and Goodfellow et al., Deep Learning (Adaptive Computation and Machine Learning series), MIT Press 2016 ISBN 978-0262035613. Furthermore, these principles and approaches may be implemented in different ways for different machine learning models in ways that the person of ordinary skill in the field will understand. Therefore, the basics and theory of training neural networks are not described in detail herein.

In an embodiment of a cooperative perception system 10 that implements a variational hypotheses approach, the ground truth data may be represented as a categorical multivariate distribution or a sample from a categorical multivariate distribution. In the first case, the ground truth may comprise a degenerate distribution. For a degenerate distribution, the categorical distribution component comprises a probability mass function (PMF) with value 1 for the known class of the object and zero for all other classes. In general, the precision matrix of a degenerate distribution has diagonal values that are exceedingly large or otherwise approaching infinity. In this representation, taking the marginal distribution along an axis corresponding to any regression parameter would result in a Dirac delta function.

In other embodiments, the ground truth may be constructed using near approximations of the preceding, or mathematically equivalent or near-equivalent forms. For example, the categorical distribution component might be incorporated as a PMF with value 0.8 or more for the known class of the object, with the sum across all other classes being 0.2 or less, and the bulk of that sum arising from the PMF for the residual class. As another example, the precision matrix may have large values along the diagonal and values near zero along various non-diagonal entries of the matrix.

To conduct the training, various loss functions may be applicable. In various embodiments, the loss functions are any suitable divergence measurements. Such loss functions may include cross entropy and Kullback Leibler (KL) divergence. For the purposes of illustration, the Kullback Leibler divergence presented in a closed format for two multivariate distributions is shown below, where index 1 represents the ground-truth distribution and index 2 represents the target:

$$L = \frac{1}{2} [ log ( \vert {Σ}_{2} \vert \vert {Σ}_{1} \vert ) - d + tr \{ {Σ}_{2}^{- 1} {Σ}_{1} \} + {( {μ}_{2} - {μ}_{1} )}^{T} {Σ}_{2}^{- 1} ( {μ}_{2} - {μ}_{1} ) ] - {Σ}_{c} {P}_{1} ( c ) log {P}_{2} ( c ) \qquad ( 6 )$$

where L is the loss function derived from KL divergence. Since we see the ground truth as a sample and the training should increase the likelihood that the output of the neural network will reproduce the ground truth when the input to the neural network is a training image corresponding to the ground truth, the parameters of the neural network are optimized by training to increase the likelihood of producing the ground truth sample in the regressed parameters output by the neural network.

While a specific exemplary loss function is described, other loss functions can be utilized. Various known loss functions can be manipulated and hyperparameters for regularization can be added. In various embodiments, a ground truth is constructed as a distribution, either degenerate or non-degenerate, alongside a representation of the strength and sign of the relationships or correlations between regressed parameters. The loss function operates on at least the distribution to revise the processing of the neural network to produce outputs more closely resembling the ground-truth representation when exposed to the corresponding ground-truth images.

The training of the neural network applies the loss function and the differentiability of the steps performed by the neural network to calculate a gradient which is used to adjust values of parameters of the neural network. The preceding steps are each generally differentiable within the constraints given and are therefore generally suitable for the training of a neural network.

An example method for training a cooperative perception system comprises: receiving at one or more machine learning (ML) systems a plurality output images produced by two or more sensors; processing the output images to yield a plurality of variational hypotheses wherein each output image is processed to provide a corresponding variational hypothesis. Each of the variational hypotheses comprises: one or more objects and, for each of the objects, values for each of a plurality of regressed parameters and variation data indicating uncertainty of the value for each of the plurality of regressed parameters. The variational hypotheses are fused to produce a fused hypothesis (which may be called a refined hypothesis). The fused hypotheses is compared with a ground truth representation by applying a loss function. Parameters of the ML system (e.g. weights and/or biases) are then adjusted based on the application of the loss function (e.g. by back propagation). Advantageously the operation(s) used to fuse the variational hypotheses can be differentiable thereby facilitating this training method.

### Sharing and Fusion of Variational Hypotheses

When a ML system 14 produces a hypothesis, the hypothesis comprises values for the regressed parameters per identified object, uncertainty measurements of the regressed parameters in the neural network and, in some embodiments, a representation of the strength and sign of relationships or correlations between regressed parameters. As previously mentioned, an exemplary form for such a hypothesis is given in equation (1).

Once plural hypotheses have been generated with respect to a common scene or environment, the multiple hypotheses can be transmitted to or otherwise received by the processor 16. As an initial step preceding fusion of hypotheses, the processor may localize objects identified by ML system(s) 14 but by different sensors 12 with different positions and poses. The localization process is may be referred to as registration. Where fusion is performed in processor 16, it may be executed, for example, by simple operators. While fusion is described in some embodiments as being performed by processor 16, one or more ML system(s) 14 may be configured to perform fusion of variational hypotheses.

Some methods currently exist within the art of object detection to perform the localization of objects across image outputs of sensors 12 with differing positions and poses. For example, some known methods use frustum representations. Frustum representations are mathematical representations of the 3D space that is visible from a particular sensor 12 viewpoint, known as a “frustum”. The frustum is the volume of 3D space that is visible to a camera and is defined by the camera's position, orientation (pose), and intrinsic parameters of the camera, such as its focal length and image sensor size.

Frustum representations can be used to determine which objects in a 3D scene are visible from a particular camera viewpoint and to exclude objects that are occluded or not within the camera's field of view. The frustum representation may be used to project the 3D coordinates of objects in the scene onto the image plane, and to determine the relationships between objects in the scene and the camera's viewpoint. Frustum representations can take various forms, such as a pyramid, a box, or a cone, and can be represented using a variety of mathematical models. Using frustum representations between two sensors 12 is one way to facilitate the identification of objects that are common to the individual frustums of the sensors and the relative localization of objects for fusion.

In some fusion approaches, variational hypotheses are filtered. If filtering is performed, the filtering may be performed before or after registration. In various embodiments, hypotheses may be filtered based on an entropy measurement of a distribution characterized by the hypothesis. Different equations may be used to calculate entropy according to the form of the distribution that is constructed from the variational hypothesis. Various forms for entropy calculation exist and the particular form used in a given embodiment may be derived based on a choice of representation of a distribution.

In various embodiments, other characteristics representing greater degrees of uncertainty in a variational hypothesis might be used to filter out hypotheses. For example, in some embodiments, the entropy marginal distribution of a categorical distribution is used to filter out (discard) distributions with higher entropy marginal distribution. Where the values and uncertainties are represented in other forms, other measures of uncertainty might be used to filter the variational hypotheses. Entropy may be calculated separately for each regressed parameter in a given variational hypothesis. Filtering does not necessarily filter out entire hypotheses. In some embodiments, a variational hypothesis for a given object may have only the output components from regressed parameters with high entropy be filtered out while output components from regressed parameters with low entropy are carried forward by the processor.

Whether or not filtering is performed, a next step in the fusion of variational hypotheses may include clustering the hypotheses. In various embodiments, divergence measurements are used to cluster variational hypotheses. Various methods of using divergence measurements to cluster variational hypotheses may be used. In some embodiments clustering is based on non-maximum suppression. Other methods for clustering may be modified to incorporate a divergence approach as described here. For example, a divergence approach may be applied to clustering methods including means shift clustering and hierarchical clustering. In general, in some embodiments one might use any of various known clustering approaches with modifications to use the divergence (or a mathematically equivalent function) of a set of registered variational hypotheses to cluster the variational hypotheses.

In an example embodiment, the processor 16 takes the registered (localized) and optionally filtered variational hypotheses from a plurality of sensors 12 and clusters the variational hypotheses by selecting one of the variational hypotheses (i.e. a hypothesis for a specific object originating from one of the sensors 12 and processed by one of the ML systems 14) that has an entropy that is lower than other variational hypotheses produced by the ML system(s). The selected variational hypothesis is used as a comparison point for clustering other ones of the hypotheses. In various embodiments, the variational hypothesis that is selected by the processor 16 is the variational hypothesis for a given object that has the lowest total entropy of all of the registered variational hypotheses for that object.

In some embodiments, the calculation of relative entropy per object is performed separately for the output components from each regressed parameter. For example, if a given first variational hypothesis for a selected object has a low entropy for a height parameter as calculated by a ML system from the output of a first sensor while a given second variational hypothesis for the selected object has a low entropy for a width parameter as calculated by the ML system from the output of a second sensor, then the distributions used as the comparison point for clustering of hypotheses may comprise the height-related output components of the first variational hypothesis and the width-related output components from the second variational hypothesis. The combination of these different output components from two or more variational hypotheses may be used to construct a lower entropy variational hypothesis to serve as a comparison point for clustering.

Once a variational hypothesis has been selected or constructed to serve as a comparison point, the divergence of each other variational hypothesis relative to the comparison point variational hypothesis can be calculated. In an example embodiment, each variational hypothesis with a divergence measurement relative to the comparison point variational hypotheses that is lower than a threshold value is selected for later fusion with the comparison point variational hypothesis. In embodiments where output components of one or more variational hypothesis have been filtered to exclude regressed parameters with higher uncertainty (e.g. higher entropy), the clustering may be applied to only the unfiltered output components of those variational hypotheses. Where output components have been filtered out during a filtering stage, the output components of variational hypotheses that have been filtered out might be not considered during the clustering stage.

The approach described here above is a divergence approach applied to a modified greedy non-maximum suppression methodology. Divergence approaches might be applied to other clustering methods, including other non-maximum suppression methods.

After variational hypotheses have been clustered, the variational hypotheses may be merged. In various embodiments in which the variational hypotheses are represented or representable as categorical multivariate distributions the merging of variational hypotheses may comprise multiplication of the distributions. In particular embodiments in which the variational hypotheses are represented or representable as categorical multivariate normal distributions the merging of variational hypotheses may comprise multiplication of corresponding ones of the distributions and renormalization of the distributions to yield a categorical multivariate normal distribution (a refined hypothesis). The multiplication of distributions may comprise the product of continuous distributions on a pointwise basis and separately the product of the categorical distributions, with each product normalized after multiplication.

Other methods of merging (sometimes referred to as aggregation) might be applied. For example, in some embodiments other methods of multiplying distributions may be applied, such as convolutions or Bayesian inference. In some embodiments, merging the hypothesis may comprise selecting from the clustered hypotheses the variational hypothesis or constructed variational hypothesis with the minimum entropy.

The general approach for fusion of variational hypotheses described here and above may be applied to various neural networks that output a plurality of regressed parameters in combination with a probability representation, such as a classification distribution or a probability distribution function (PDF) that indicates the probability that an object is located at a position corresponding to a particular coordinate value as a function of the coordinate value. The probability distributions of the refined hypothesis may define a volume within which the object is located with a desired probability. The volume may be smaller than the equivalent volume determined based on probability density functions from any of the merged hypotheses taken individually.

### Variational Hypothesis Feature-Kernel Sharing and Fusion

In some embodiments, methods and systems are described for cooperative perception in which intermediate products of the ML systems are shared from a plurality of ML systems 14 and fused before continuing processing of the fused intermediate products within one or more other ML systems, such as a 3D CNN. In some embodiments, a cooperative perception system 10 comprises a plurality of neural networks. For example, in a cooperative perception system 10 may comprise an initial ML system 14 and a second ML system 14 comprising a 3D CNN or a GNN (graph neural network). A plurality of neural networks may operate with the neural networks either or both of series and parallel arrangements. The training of a cooperative perception system 10 with a plurality of neural networks may comprise training any subset of the neural networks in the system individually or collectively. In embodiments where multiple ML systems 14 are trained individually and in which ML systems 14 interact on a feed forward basis (e.g. a first ML system computes intermediate results which are further processed by a second ML system), one ML system may be treated as hard-coded while the other ML system is trained and its parameters are adjusted.

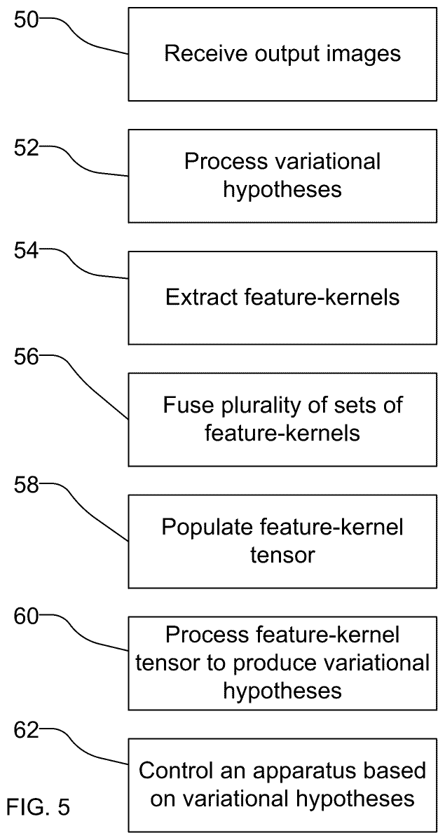

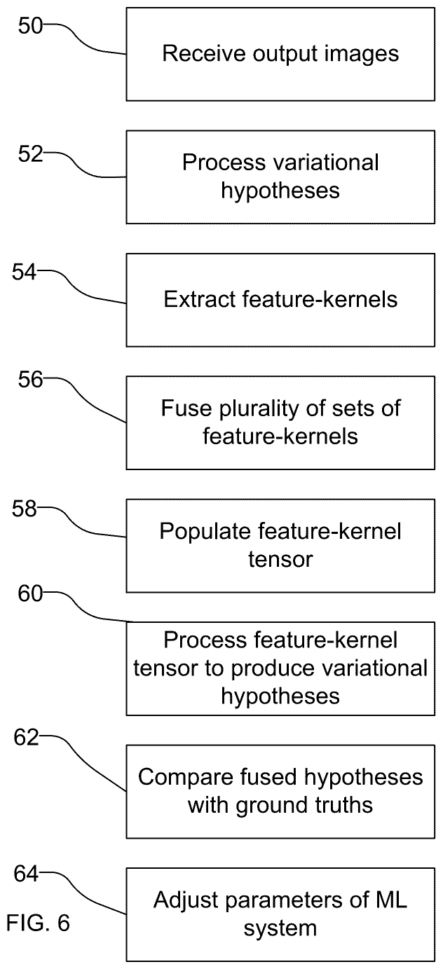

FIG. 5 is a flow chart showing the steps taken by an example fully-trained ML system 14 in a cooperative perception system 10 performing feature-kernel sharing and fusion.

In step 50, one or more ML systems 14 receives output images from a plurality of sensors 12. Each of the ML systems 14 has been trained (e.g. as described elsewhere herein) to incorporate channels in intermediate layers that represent uncertainties in one or more regressed parameters. In some embodiments, this may comprise training a ML system to generate variational hypotheses. In step 52 the one or more ML systems process the input images. As part of the processing an intermediate layer of the ML system 14 generates outputs that may be called “feature kernels”. Each feature kernel comprises a set of values that are respectively associated with one of a plurality of channels. Each feature kernel is associated with a location in the field of view of the input image. To this point, the processing of the input image may be identical to that performed to output variational hypotheses as described elsewhere herein.

The output images from each sensor are processed in step 52 as if to develop sets of variational hypotheses in a coordinate space of the sensor 12 from which the output images were produced. However, as an alternative to fusing variational hypotheses, intermediate products, e.g. feature-kernels, produced at the intermediate layer of the neural network are extracted in step 54. In step 56, the sets of feature-kernels are fused.

Because each feature kernel corresponds to a location, fusing of the feature kernels may be performed by a process that is closely analogous to the method described elsewhere herein for fusing variational hypotheses. The fusion of feature-kernels may comprise the registration, filtering, clustering and merging of feature-kernels. In some embodiments where feature-kernels are derived from 2D sensors then depth anchors are used to incorporate depth information in the feature-kernels.

Once feature kernels have been fused in step 56, a feature-tensor is populated in step 58. The feature-tensor is fed-forward to another trained ML system, such as an appropriately configured 3D CNN, to generate a variational hypothesis in step 60. 3D CNN systems are described for example by: Ben Graham. Sparse 3D convolutional neural networks. Bmvc, pages 1-11, 2015; Daniel Maturana and Sebastian Scherer. VoxNet: A 3D Convolutional Neural Network for Real-Time Object Recognition. pages 922-928, 2015; and Zhirong Wu and Shuran Song. 3D ShapeNets: A Deep Representation for Volumetric Shapes. IEEE Conference on Computer Vision and Pattern Recognition (CVPR2015), pages 1-9, 2015. While 3D CNNs are referred to in some embodiments, a 3D CNN operating a 3D feature tensor may be replaced by other methods that operate on 3D voxels (3D tensors).

The resulting variational hypothesis may be used control an apparatus based on the information in the hypotheses in step 62. Controlling an apparatus may take many forms. Some examples of using cooperative perception systems to control an apparatus are described in greater detail elsewhere herein.

An example method for training of a ML system 14 to operate in a cooperative perception system 10 using shared feature-kernels is illustrated in FIG. 5. As in the case of directly processing variational hypotheses, the initial steps of training a ML system 14 are similar to the steps of operating a trained ML system 14. As in the trained version, the ML system 14 here receives output images in step 50, processes the output images in step 52, extracts feature kernels in step 54 and fuses a plurality of feature kernels in step 56. The fused feature kernels are used to populate the feature tensor in step 58, and the feature tensor is used to produce variational hypotheses in step 60, the variational hypotheses are compared to ground truths in step 62. As described elsewhere herein, the comparison may performed using a loss function as described further below in this text. In step 64, the comparison of the fused hypotheses against the ground truths is used to adjust parameters of one or more of the ML systems.

The intermediate products may comprise feature kernels extracted from intermediate layers of a neural network such as a CNN or DNN, that are trained, or are being trained, to generate uncertainty estimates of one or more of the regressed parameters. This may comprise, for example, training a ML system to generate variational hypotheses as previously described herein. The feature kernels are extracted from the intermediate layers of ML systems processing image outputs from a plurality of sensors. Since the ML systems are trained, or are being trained, to generate uncertainty estimates, the feature-kernels contain feature-information that may be characterizable as probability distributions, such as, in various embodiments, multivariate probability functions per class. In general, modifications can be made to the architecture, outputs and training of a neural network to provide uncertainty information in feature-kernels that can be interpreted as probability distributions.

This methodology can be applied to systems comprising uni-modal or multi-modal systems. The application to multi-modal systems requires additional steps which are described in greater detail further below.

In various embodiments, feature kernels are extracted from intermediate layers of a neural network. Each pixel of the feature map is referred to as a fixel. The neural network may comprise, for example, a CNN or a DNN. To construct the feature kernels as a probability function, a probability function is defined in terms of the classes being identified and the regressed parameters. A probability density function (PDF) usable in various embodiments to process image outputs from 2D sensors is defined below as equation (7)

$$p ( x , c ) = {p}_{c} {\vert Σ \vert}^{- \frac{1}{2}} {e}^{- \frac{1}{2} {( x - μ )}^{T} {Σ}^{- 1} ( x - μ )} \qquad ( 7 )$$

where p_{c} indicates the probability of a Gaussian kernel belonging to class c for a set of disjoint classes C, and x is a regressed parameter, and Σ is a covariance matrix. We can denote a number of feature abstractions by K, such that the number of partitions (classes) within abstract index k is C. Under this construction, if the input image from a 2D sensor 12 to a neural network of a ML system 14 has the size H×W×3 then the neural network can be configured to produce an output with the size of Hₜ×Wₗ×((N+C) K) assuming that each abstraction has the same number of partitions, and where N is the number of parameters required to describe the multi-variate distribution, His the height in pixels of the image output of the sensor 12 and Wis the width in pixels of the image output of the sensor 12. Hf and Wf are the height and width in fixels of the filter at the intermediate layer at which the feature kernel is extracted.

This approach can be applied broadly to various neural network systems by appropriate interpretation of the parameters estimated in the intermediate layers of the network, e.g. by construction of probability functions defined in terms of the classes and the regressed parameters.

In various embodiments, the image outputs from 2D sensors may have depth regressively determined from the feature kernels of the outputs, i.e. depth may be estimated by the neural network as a regressed parameter included in the feature kernel. This approach in its application here is called depth-anchor regression. In this approach, a number of anchors are added to the channels of the feature. The number of anchors that may be added may be determinable by the existing channels in the feature-maps based on the modality of the sensor 12. For example, for the RGB camera described above with size H×W×3, then if the number of anchors is denoted by A, the number of channels might be equal to (N+C+A)*K. In this example, each abstraction is also determining which depth anchor is added to the regressed depth value of the feature-kernel. Therefore, each fixel produces a number, K, of abstractions that each contain a number, C, of classes and a number, A, of depth anchors and a number, N, of parameters for the multivariate normal distributions

In various circumstances and in some embodiments, each depth anchor may correspond to a different normal distribution kernel. In such a scenario with a 2D RGB camera, the number of channels might be equivalent to (A*N+C)*K. In this scenario, it is assumed that the categorical random variable is independent of the positioning of the feature-kernels random variables. A third approach assumes that the categorical random variable is not independent from the positioning kernel. In this case, the number of channels might be equal to A (N+C)*K for the 2D RGB camera.

In some embodiments, a class in any abstraction can be considered as a no-abstraction class to make tensors sparse by enforcing that areas without any valuable information produce kernels belonging to the no-abstraction category.

Once the channels for the depth anchors have been configured, the estimated mean parameters of normal distributions corresponding to the depth offset are added to the predefined corresponding anchors. This process may adopt methodology used in YOLO object detection methods for localizing an object in an image which operate on the final output of the ML system as described, for example, in “Categorical Depth Distribution Network for Monocular 3D Object Detection” by Reading et al., arXiv: 2103.01100. Other methods for estimating values to be added to the anchors may be used. The estimated mean parameters corresponding to the offset of the feature-map are added to the index of the fixel position in the feature-maps.

The kernels may be projected to the sensors local coordinate system using a combination of one or more of the feature map properties (e.g. filter resolution) and the sensor properties of the sensor from which the feature map was derived (e.g. a known location and pose), as well as properties in the camera intrinsic matrix and estimated depth.

The extracted kernels may then be broadcasted to be received by cooperative agents. Since each transmitted deep feature has been constructed as a distribution, the depth estimation limitation of frustum approaches due to memory limitations is alleviated. To further reduce memory limitations and transmission time, kernels with high measures of uncertainty, such as high Shannon entropy or other measures of uncertainty can be filtered out and omitted from transmission. In some embodiments, a regularization step may be applied to force kernels to have a minimum entropy in order to sparsify the feature-maps. Such methods of regularization are known in the art. In one example one can use an L1 or L2 norm regularization to suppress features which have high entropy. Known methods of sparsifying may be applicable, such as those described in “Sparsity in Deep Learning: Pruning and growth for efficient inference and training in neural networks” by Torsten et al. (arXiv: 2102.00554v1).

The incorporation of depth information may assist with allowing for a robust alignment method for multiple sensors configurations and especially multi-modal sensor configurations. In multi-modal configurations, the inferred the depth information of the feature maps derived from the 2D sensor image output can be combined with the depth information present in volumetric 3D sensor images to process the alignment of the various sensors. The depth information, whether inferred (e.g. 2D sensors) or inherent (e.g. 3D sensors) can be used in combination with extrinsic sensor information such as positioning, pose and heading information of the sensors to facilitate the alignment process by conventionally known methods. The alignment process may be performed using rotation and translation of the feature kernels with respect to the receiver sensor's heading and positioning information to align kernels to a common coordinate system.

The preceding steps for feature kernel extraction and depth inference are each differentiable and therefore have particular utility in combination with a loss function for training of a neural network to perform cooperative perception using fused feature-kernels.

Any of various divergence approaches may be used to perform registration of the feature kernels. In various embodiments, Jensen Shannon divergence is used. Jensen Shannon divergence is symmetric, bounded and has a closed form function for application to normal distributions. In such embodiments in which feature-kernels are constructed and interpreted as categorical multivariate normal distribution kernels, the divergence measure can be used to determine the similarity of the two distributions. Using a symmetric divergence function allows to calculate the probability of the two distributions belonging to the same object.

In some embodiments, Kullback-Leibler divergence (KLD) might be used. In such cases, the probability can be obtained by exponentiation of the negated symmetric KLD measure.

In any of various embodiments using a suitable divergence function, the divergence of pairs of feature-kernels are calculated. As discussed previously elsewhere herein with respect to clustering of variational hypotheses, a feature-kernel with lower entropy may be selected as a comparison point feature-kernel, and the divergence of all other feature-kernels from the comparison point feature-kernel may be compared. This process can be parallelized utilizing a GPU. The divergence measure can be used as a distance measure for clustering the kernels for fusion.

Using a divergence measure applied to greedy NMS approach, the feature-kernel with the highest classification confidence is selected as a candidate and any hypotheses with a divergence from the candidate that is lower than a given threshold can be used to define a cluster. Other methods of identifying clusters may be used and may be selected based on choice of uncertainty measure or divergence measure.

After clustering, the processor 16 may perform fusion of the clustered feature-kernels. Where fusion is performed in processor 16, it may be executed, for example, by a simple or complex operators. While fusion is described in some embodiments as being performed by processor 16, one or more ML system(s) 14 may be configured to perform fusion of variational hypotheses. In some embodiments, fusion may comprise summation and renormalization of the feature kernels. Summation may provide the benefit of being computationally simple, but may become unstable in the limits of large numbers of sensors (e.g. many cooperative perception vehicles on the same road). In some other embodiments, fusion of feature-kernels is performed as a product of the distributions in which the feature-kernels have been constructed. For example, where the feature-kernels have been constructed as categorical multivariate normal distributions, fusion may take the normalized products of the distributions. The renormalized product may allow for higher stability of the system in the limits of large numbers of sensors and large numbers of feature-kernels. This approach may also be trained on smaller numbers of cooperative sensors while maintaining fidelity when applied to larger numbers of sensors. This method is non-parametrized as compared to, for example, a GNN (graph neural network) based fusion method.

In this approach, the multivariate normal distribution is assumed to be independent of the categorical distribution. The normal distributions can be fused by application of equations (8) and (9), in which the closed form function for calculating the normalized product of the normal distributions precision matrix is:

$${\hat{Σ}}^{- 1} = \sum {\hat{Σ}}_{ijk}^{- 1} \qquad ( 8 )$$

while the mean of the fused normal distributions can be calculated by:

$$\hat{μ} = \hat{Σ} ( \sum {\hat{Σ}}_{ijk}^{- 1} ( {μ}_{ijk} ) ) \qquad ( 9 )$$

The normalized product of the categorical distributions is the normalized inner product of the probability vectors.

The normalized fused kernels can be fed back into an appropriate neural network (e.g. a 3D CNN). In order that the ML system can be trained using a selected loss function, it may be preferable that functions applied to the feature kernels (e.g. the construction of a feature tensor as described herein) are differentiable. In an exemplary embodiment, a tensor is constructed with a size of H₂×W₂×D₂×(K*C). We denote this tensor by X, where (K*C) is the number of channels of the constructed 3D tensor. The values of each voxel in the tensor can be associated with coordinates in a common 3D coordinate system (e.g. a world coordinate system). A differentiable function, for example as shown in equation (10) can then be constructed from X and the volumetric feature-map.

$$Y ( c , k ) = {\sum }_{x , y} {p}^{xy} ( c , k ) f ( X ; {μ}_{c}^{xy} , {Σ}_{c}^{xy} ) \qquad ( 10 )$$

where f(.) indicates the 3D normal distribution PDF, μ_{c}^{xy}, Σ_{c}^{xy} indicates the mean and covariance matrix of a Gaussian kernel with partitioning index k proposed by the pixel at coordinates x and y of the RGB feature-map for c in Cₖ. Furthermore, p^{xy}(c,k) is the probability of the Gaussian kernel belonging to the class (partition) c where cis a member of classes defined by abstraction k. The following rule set out in equation (11) can be enforced using a softmax function:

$$∀ k ∈ K {\sum }_{c ∈ {C}_{k}} {p}^{xy} ( c , k ) = 1 \qquad ( 11 )$$

This rule can be used to ensure that for each abstraction the probability of the Gaussian kernel belonging to one of the classes in the abstraction adds up to exactly 1.

In equation (9), μ can be calculated by using a linear transformation on the estimated depth and coordinates of corresponding pixels using a camera projection matrix. This leads to the construction of Y as a 3D tensor with C*K number of channels such that Y (c,k) corresponds to partitioning k and class c.

While various embodiments have described registration and/or conversion of coordinates into a selected 3D world coordinate system, other coordinate systems could be used as the coordinate system into which hypotheses or feature-kernels are converted. For example, variational hypotheses or feature-kernels could be converted onto a Bird's Eye View plane, as opposed to 3D world coordinates.

The fused feature-kernels can be fed into an appropriate neural network (e.g. a 3D CNN) for the continued processing and hypothesis development of object in the scene. For example, in various embodiments the 3D feature-tensors described in association with equations (10) and (11) can be processed by any of various 3D object detection neural networks. The loss function and training algorithm for such a neural network may be any of various loss functions, including those described previously in relation to variational hypotheses. For example, the loss functions may comprise the use of cross entropy or Kullback Leibler (KL) divergence.

As described elsewhere herein, the loss function and training algorithm may be used to train individual neural networks in a cooperative perception system 10 using a plurality of neural networks. For example, in a feature-kernel sharing approach, a 3D CNN ML system used to process fused feature-kernels may be trained separately from a ML system trained to generate outputs in the form of variational hypotheses and which is used to generate feature-kernels for sharing and fusion.

While these methods for feature-kernel fusion above have been described with reference to feature-kernels derived from 2D sensors such as RGB cameras, corresponding methods may be applied to other modalities of sensors with appropriate modifications. For example, for feature-kernels deriving from 3D capable sensors such as LiDAR sensors. The feature-kernels may not require depth-anchoring as previously described. Rather, depth is incorporated in the LiDAR image output. Other steps, including the construction of a probability function, clustering and merging, and the development of a tensor function may be performed analogously. One approach to feature-kernel extraction where feature-maps are derived from volumetric sensors applies a 3D CNN.

### Methods of Multi-Modal Feature-Kernel Fusion and Training Thereof

In various embodiments the group of sensors producing image data of a given scene is multi-modal. For example, in some embodiments there are a plurality of 2D sensors (e.g. RGB cameras) and a plurality of 3D sensors (e.g. LiDAR). Multiple embodiments are described here below for processing sensor outputs deriving from sensors with different modalities. Two methods of fusing feature-maps across sensors of different modalities are described here below.

In some embodiments, feature-kernels are categorized by the modality of the sensors (e.g. RGB camera, LiDAR, RADAR) from which they have been produced. The feature-kernels within each category are registered and fused and a fused feature-tensor is created for each category. The feature tensors for each category can then be concatenated. For example, the feature-kernels deriving from RGB cameras define a category of feature-kernels. These feature-kernels are fused to develop a 3D feature tensor as described previously. The feature-kernels deriving from LiDAR sensors are fused separately to develop another 3D feature-tensor for the LiDAR category. If the sensors in the network comprise only RGB cameras and LiDAR sensors, then these two feature-tensors can be concatenated and processed by the neural network accordingly.

In a feature-kernel sharing cooperative perception system, a first ML system and a second 3D CNN ML system trained according to this approach can be trained against a selected set of modalities, but may require retraining of the network to accommodate new modalities for which it was not trained.

In some embodiments, feature kernels are constructed and extracted as previously described for the image outputs of all of the sensor modalities being used. If image outputs from 2D sensors are involved, depth is inferred using an appropriate approach such as frustum representation or deep-anchor regression. Once 3D feature maps have been extracted, the 3D feature maps are registered so that the feature-maps are aligned in a common coordinate system. The registration may use the inferred or explicit depth information in the various feature-kernels, as well as camera intrinsic and extrinsic functions including the camera position and pose.

Training may performed using a method that selects groups of feature kernels for fusing that include different mixtures of feature kernels derived from sensors that operate in different modalities. For example, feature vectors to be fused in a training iteration may be selected randomly from the multi-modal feature kernels for feed-forward into the neural network. By mixing the modalities during common steps in training, the ML system may be trained to be agnostic regarding the modality of the sensor from which the feature-kernel it is processing is derived. The feature-kernel fed forward to the neural network may comprise a feature kernel that is fused across a subset of the feature-kernels present in the training set, with the subsets randomly selected.

Various methods may be used to randomize the selected feature-kernels or combinations of feature-kernels fed forward to the neural network. For example, an approach might incorporate a random chance that any feature-kernel from the set of feature-kernels available is selected for the feed forward. For example, consider the case where there are twenty-five feature kernels from twenty-five sensors 12 with four different modalities, the network may randomly select feature-kernels by a process in which each feature-kernel has a 1/10 probability of being selected for feed-forward. Whenever a plurality of feature-kernels are selected, they are fused for the purposes of the feed forward.

This process may use any appropriate loss function for training, including KL divergence as previously described.

### Exemplary Illustrations of Feature Kernel Sharing

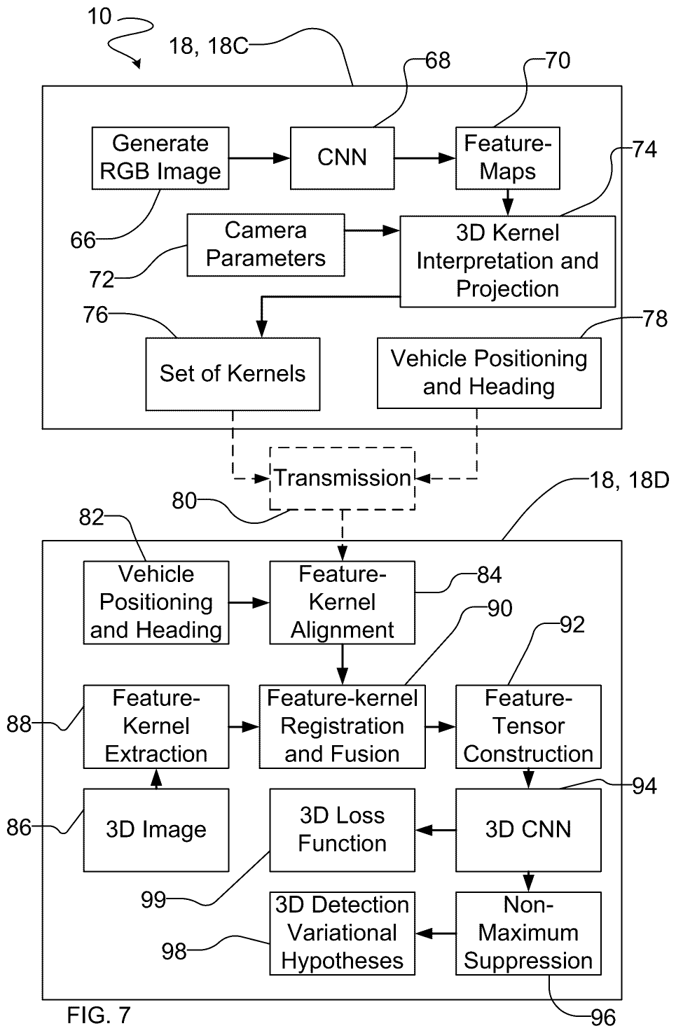

FIG. 7 is an exemplary illustration of a cooperative perception system 10 implementing feature-kernel sharing. Two vehicles 18 are schematically shown. In cooperative vehicle 18C, a sensor 12 (not shown) produces an RGB image in block 66. An ML system 14 (not shown) uses a CNN in block 68 to produce feature maps, block 70. ML system 14 uses camera parameters in block 72 to interprets the feature-maps and projects them in block 74 to generate a set of feature-kernels 76. The set of feature-kernels 76 and the cooperative vehicle's positioning and heading 78 are transmitted wirelessly through transmission means 80 to a primary vehicle 18D.

The primary vehicle combines the received cooperative vehicle's positioning and heading 78 and received set of feature kernels 76 with the primary vehicles own vehicle positioning and heading 82 to perform feature kernel alignment into the primary vehicles coordinate system or a world coordinate system in block 84. The primary vehicle also takes a 3D image 86 from one of its own sensors 12 (not shown) and partially processes the 3D image to extract feature-kernels in block 88 from the 3D image. In block 90, the aligned feature kernels from block 84 are registered and fused with the extracted feature-kernels from block 88. The fused feature-kernels are used to construct a feature-tensor in block 92. This feature-tensor is fed-forward into a 3D CNN for processing in block 94. Non-maximum suppression may be applied in block 96 to generate variational hypotheses in block 98. If the system is still being trained, then a loss function can be applied to the products of the CNN, in block 99.

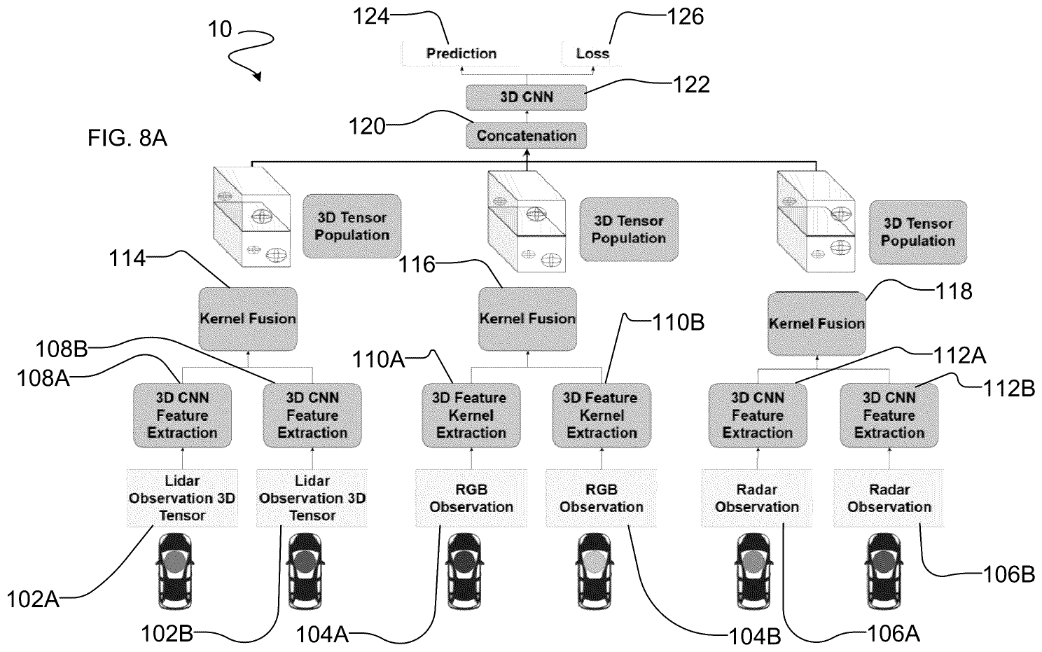

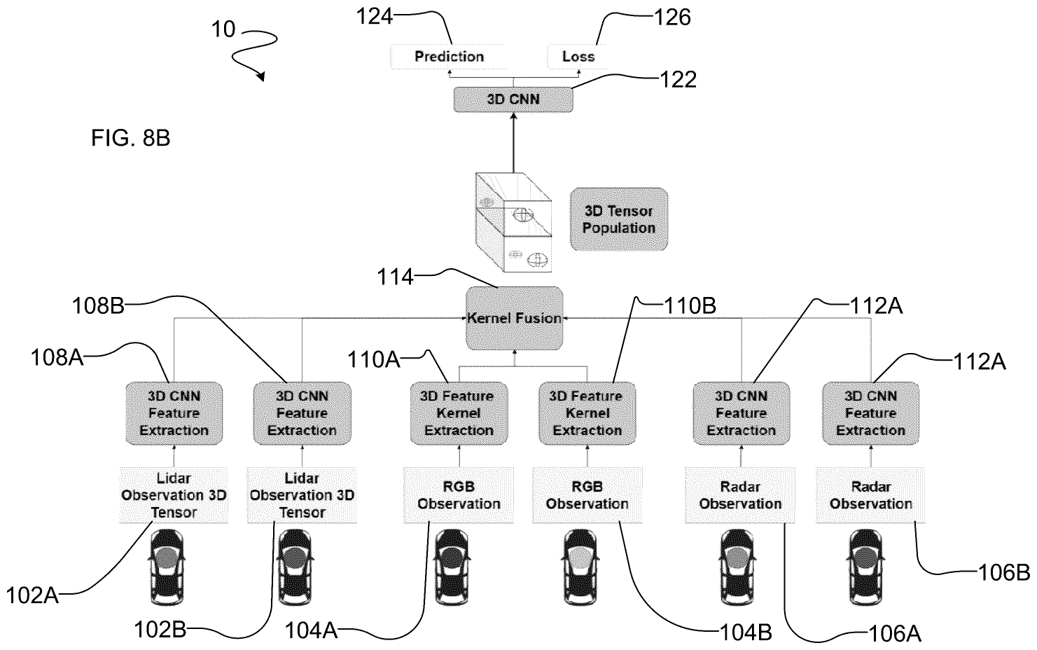

In FIG. 8A, cooperative perception system 10 using a concatenation process for multi-modal feature kernel sharing is illustrated. In this process, a plurality of sensors 12 produce output images with a plurality of modalities. Vehicle 102A and 102B comprise LIDAR sensors, vehicles 104A and 104B comprise RGB cameras and vehicles 106A and 106B comprise radar sensors. Features maps are extracted from each of the image products of the sensors in blocks 108A, 108B, 110A, 110B, 112A, and 112B respectively. The extracted features maps of common modalities are aggregated into 3D tensors in blocks 114, 116, and 118. The results are then concatenated in block 120 and fed-forward into a 3D CNN in block 122. This system can then produce a prediction in block 124 or be processed with a loss function in block 126 for further training of the 3D CNN and/or ML systems 14. FIG. 8B illustrates a cooperative perception system 10 using a probabilistic approach to fusing multi-modal feature kernels.

An example method for training a cooperative perception system which is configured to share feature maps comprises: providing a set of training output images from a plurality of sensors as inputs to one or more machine learning (ML) systems. Each set of training images is associated with ground truth information. In some embodiments each sensor has a dedicated ML system. In some embodiments images from two or more sensors are input into the same ML system. The one or more ML systems may have ben trained to output variational hypotheses at an output layer as described elsewhere herein. An intermediate layer of the of the ML systems produces feature maps. Each feature map may include plural feature kernels. Each feature kernel may be associated with a location relative to the sensor. In some embodiments each of the feature-kernels comprises: one or more abstractions and, for each of the abstractions, values for each of a plurality of regressed parameters and variation data indicating uncertainty of the value for each of the plurality of regressed parameters. In some embodiments the ML systems are truncated after initial training by deleting all layers following the intermediate layer that produces the feature maps.

Feature maps from the ML system may then be fused to yield a fused feature map. Fusing the feature maps may be performed as described elsewhere herein and/or in the same manner as fusing variational hypotheses as described elsewhere herein. The method may proceed by inputting the fused feature maps into a second ML system configured to output a refined hypothesis (which may be a variational hypothesis). The refined hypothesis is then compared to the applicable ground truth representation by applying a loss function. Parameters of the ML systems and/or the second ML system (and optionally a processor that performed fusion of the feature maps) is performed by back propagation. Advantageously the entire system including the ML systems, the second ML system and the operation of fusing feature maps may be differentiable, facilitating training of the entire cooperative perception system from end to end.

### Applications of Multi-Sensor Variational Hypotheses Object Detection in Vehicular Domain

A cooperative perception system 10 may use either or both of a variational hypotheses approach and a feature-kernel sharing approach in object detection. In a cooperative perception system, the fusion of information may be used to extract meaningful information about the locations and shapes of objects to improve object identification and other predictions of the network.

One application of variational hypotheses in a cooperative perception system 10 may be the fusion of 2D variational hypotheses with 3D variational hypotheses. This may comprise, for example, the construction of a 3D categorical multi-variate normal distribution from a 2D categorical multivariate normal distribution from a 2D sensor, and the fusion of the constructed 3D categorical multi-variate normal distribution with a second 3D categorical multi-variate normal distribution from a 3D sensor.

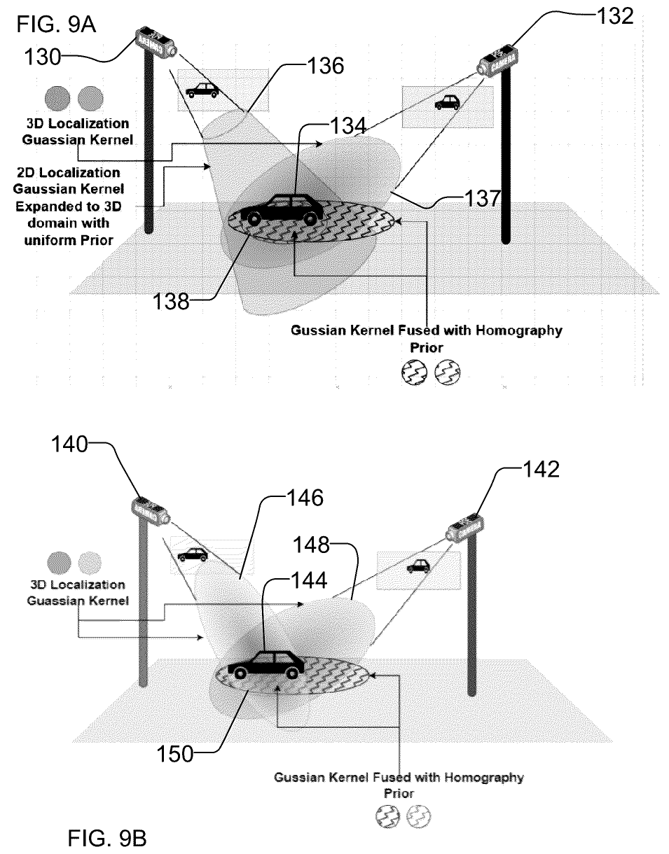

FIGS. 9A and 9B illustrate two outcomes of applying a cooperative perception system 10 with variational hypotheses. In FIG. 9A, a 2D sensor 130 and a 3D sensor 132 view a scene containing a vehicle 134. The Gaussian kernel of the 2D sensor 130 is initially a 2D distribution in a 2D image plane. This localization Gaussian kernel can be expanded into 3D. In this example, the expansion into 3D is treated as having a constant size when projected into 3D space forming a conical shape 136 as described elsewhere herein. The 3D localization Gaussian kernel of the 3D sensor 132 extends into 3D space and can be represented as an ellipsoidal shape 137 in a 3D coordinate system. After alignment and registration, the two Gaussian kernels can be fused, along with a homography prior to provide a fused Gaussian kernel 138. The homography prior is an assumption that the geometric relationship between two images of the same scene remains constant under perspective transformation, for example, a previous detection of the same object in a previous frame within a short period of time. The homography prior can be fused by incorporating the homography prior as a distribution of its own in the current hypothesis space.

FIG. 9B illustrates two 3D sensors 140, 142 viewing a common scene containing a vehicle 144. The 3D localization Gaussian kernels 146, 148 can each be represented as ellipsoidal shapes in the common world coordinate system. After alignment and registration, the two Gaussian kernels can be fused, along with the homography prior, to provide a fused Gaussian kernel 150.

To convert a 2D variational hypothesis into a 3D variational hypothesis, the 2D variational hypothesis may be extended into the 3D coordinate space. One approach to extending into 3D space is set out here for the conversion of a network output that is a categorical multivariate normal distribution.

A categorical multivariate normal distribution (CMND) is an outer product of a multivariate normal distribution and a categorical distribution. To convert a 2D CMND into a 3D CMND, we can covert a 2D multivariate normal distribution to a 3D normal distribution and the multiply the expanded 3D normal distribution with the categorical distribution. This method can be applied to other outputs of the network. For example, where the network predicts a Gaussian kernel (e.g. the assumption wherein categories are not independent of regressed parameters), this method can be similarly applied.

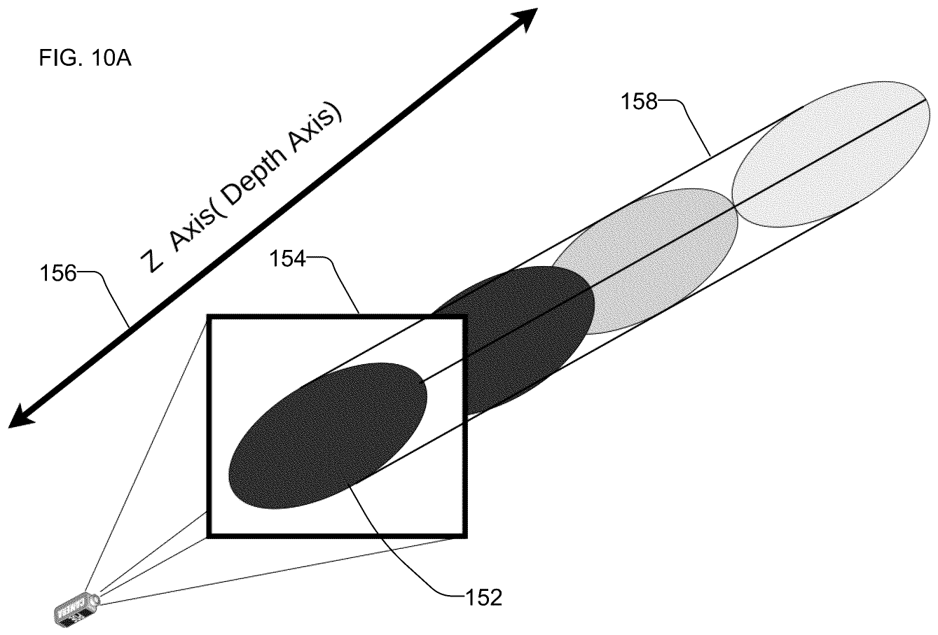

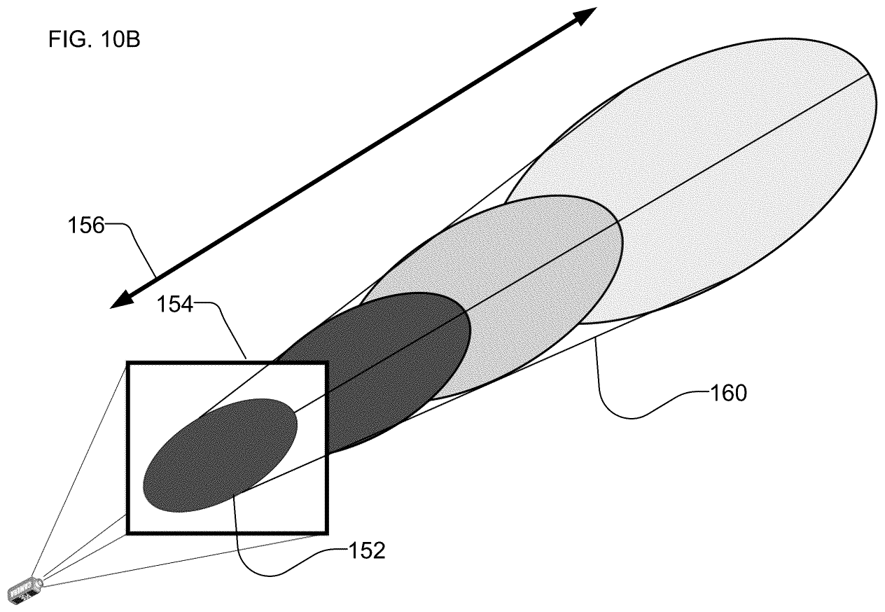

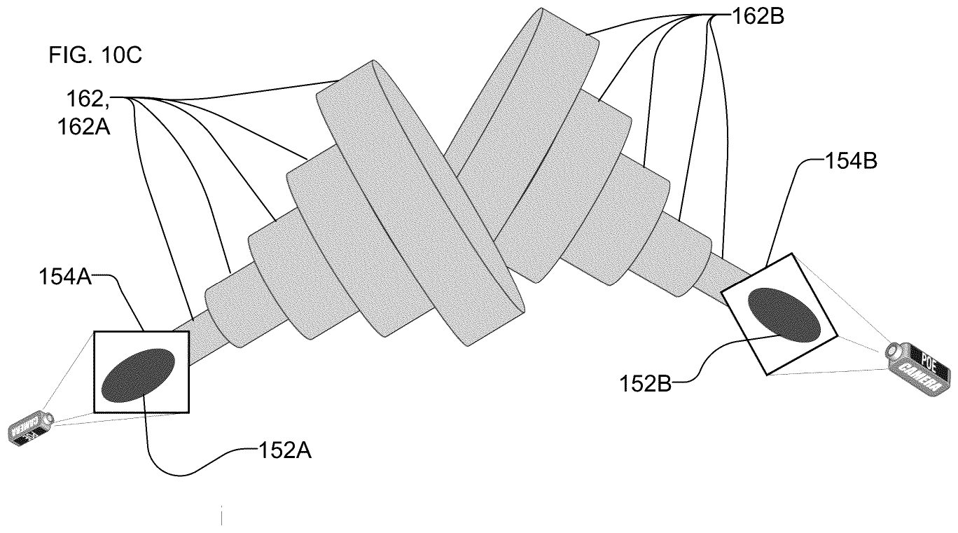

Each 2D kernel may comprise a position of an object in a 2D coordinate system, such as an image plane. The 2D structure can be back projected into the 3D world in a conic manner as illustrated in FIG. 10B. In FIG. 10B, the image is shown as the projection of an ellipsoid into a 3D space. This approach starts by estimating a 3D distribution of the position of the object in the 3D world coordinates based on the 2D distribution of the position of the object. This approach does not estimate the depth of the object per se but scales related to the parameters (a distribution) into the depth dimension.

As discussed previously, the network produces u and E which define the parameters of the multivariate normal distribution in the image coordinate system. We denote the camera intrinsic matrix as K. The image plane can be transformed to the camera coordinate system. The image plane is defined in a coordinate system based on pixels coordinates (u,v). The camera coordinate system is based on world coordinate system measure (x,y). The units for the coordinates in the world coordinate system may be any standard units, e.g. meters, yards, etc. There are multiple possible approaches to the transformation between coordinate systems. Described here is a non-homogenous approach. Matrix K is a 3×3 matrix. The matrix K can be broken down into a 2×2 matrix M representing the rotational component of converting from pixel coordinates to the world coordinate system and a 2×1 vector t representing the translational component of converting from pixel coordinates to the world coordinate system. Then equations (12) and (13) apply:

$${μ}_{xy} = {M}^{- 1} {μ}_{uv} + t \qquad ( 12 )$$

$${Σ}_{xy} = {M}^{- 1} {{Σ}_{uv} ( {M}^{- 1} )}^{T} \qquad ( 13 )$$

The kernel is then expanded to construct a 3×3 precision matrix Σ⁻¹_{xyz}. The first 2×2 block of the matrix is filled with the values of Σ⁻¹_{xy} as calculated from equation (13), and the rest of the values are set to zero. This result is representative of a degenerate 3D distribution as a cylinder with infinite length. Technically, at this stage the variance of the kernel along the z axis is infinite and the variance in x-axis and y-axis is consistent. However, the variance of the normal distribution is assumed to be proportional to the z coordinate. As z increases the variance along the x and y direction should increase. This can be thought of as converting the constructed cylindrical multivariate distribution to a conic multivariate distribution. This adjustment is made in subsequent steps. At this stage, the constructed degenerate 3D multivariate distribution can be understood as represented in FIG. 10A, in which we see that the multivariate distribution 152 is projected cylindrically indefinitely out of image plane 154 into the z-axis 156 as shown by cylindrical bounds 158.

The desired conic multivariate distribution is illustrated in FIG. 10B, in which the multivariate distribution 152 is projected conically indefinitely out of image plane 154 into the z-axis 156, as shown by conical bounds 160.

The product of multiple conic multivariate distributions has a complex closed form function. In some embodiments, a piecewise approximation of the conic multivariate distribution is used to simplify a representation that approximates the conic multivariate distribution form. However, the full complex close form function could still be applied in various embodiments. A representative illustration of the piecewise approximation is shown in FIG. 10C. By finding the point at which the distributions are estimated to intersect, that depth of that point can be used to calculate the disc 162 which best approximates the conic distributions at that depth. Each disc 162 represents a normal distribution with scaled covariance matrix with respect to the depth relative to the camera image plane.

In this method, the CMND is transformed into the world coordinate plane. Various methods can be applied to determine the depth at intersection. One method is to find a point that has minimum distance from lines that run through the apex of the cones to the center of the base of the cone at any slice. The objects 152A and 152B are back projected linearly (e.g. projected cylindrically as in FIG. 10A) into the 3D world space. A point of closest approach is found where the distance between their back projections is closest (i.e. the point where the distance between the centers of distribution 152A and distributions 152B is smallest). In other words, the point of closest approach is a point that has minimum distance from the back projected mean of the estimated multivariate normal distribution. Once this point or points are found, the depth of intersection is the distance of the point from the camera centers.

This point of closest approach is used to calculate the size of the disc 162 that represents the piecewise approximation of the conic multivariate distribution. The point of closest approach is understood as the point where the two conic normal distributions would intersect and the covariance is scaled based on the depth at which the two or more conic normal distributions are estimated to intersect.

The variance of the normal distributions is then scaled accordingly. This approach can be made for conic normal distributions and 3D normal distributions. While this approach is described and illustrated with respect to the extension of image coordinates into 3D space, the same approach could be applied to any 3D world coordinate system with appropriate rotation and translation of the functions and outputs.

In the previous approach, the multivariate normal distribution was back projected to estimate a center of the object. However, the same approach can be used to back project shape information of the object with appropriate modifications based on the nature of the regressed parameter. For example the position of the sensor may not affect the transformation applied on estimated height and width of the orientation of the object in the common coordinate system. In another example, the pose of the sensor may not affect the width and height and length of the object. The approach used to back project information relating to a regressed to parameter may be selected according to the case.

Once the distributions have been scaled based on their point in the conic piecewise extension in depth, fusion can be applied to produce the product of normal distributions. Alignment (or registration) of the variational hypotheses is performed to bring the two hypotheses into a common coordinate system. This alignment may use the camera intrinsic and camera extrinsic functions. Assuming that the camera projection matrix and the relative coordinates of the cameras are known, this alignment can be performed with a simple translation and rotation of the coordinates and a corresponding translation and rotation of the distributions.

This stage of fusion is comparable to that described for feature-kernel sharing and fusion described previously. The result is similar to equations (8) and (9) in that section. The resulting covariance matrix of the product of normal distributions can be calculated as in equation (14)

$$\hat{Σ} = {( \sum {\hat{Σ}}_{i}^{- 1} )}^{- 1} \qquad ( 14 )$$

while the mean of the fused normal distributions can be calculated by equation (15)

$$\hat{μ} = \hat{Σ} ( \sum {\hat{Σ}}_{i}^{- 1} {μ}_{i} ) \qquad ( 15 )$$

Another use of variational hypotheses in a cooperative perception system 10 is to incorporate prior information. Separate from the use of ground truths, prior information comprises information that can be used to adjust or constrain predictions. Examples of prior information include the estimated sizes of humans, sizes of vehicles per model, the pose of a given sensor 12 with respect to a road. Some prior information can take the form of constraints or assumptions. For example, a system could assume that vehicles are more likely to be present on road than they are likely to be present on sidewalks and therefore penalize predictions that suggest a vehicle is off of the road and on a sidewalk. Various types of prior information and applications of prior information to adjust or constrain ML system hypotheses are known in the art, such as those presented in Murthy, J. Krishna, et al. “Reconstructing vehicles from a single image: Shape priors for road scene understanding.” 2017 IEEE International Conference on Robotics and Automation (ICRA). IEEE, 2017.

To coordinate variational hypotheses and prior information, the prior information may be converted into a common state space as the variational hypothesis. Different forms of prior information may be suitable for different representations in the common state space. Some examples of these forms are given here below. In general, where variational hypotheses are represented as multivariate distributions then a sample of prior information can be converted to a representation as a multivariate distribution. In particular, in embodiments in which variational hypotheses are constructed as categorical multivariate normal distributions, some prior information may be represented as degenerate multivariate normal distributions.

One example of prior information that may be incorporated is the ground plane. For clarity of explanation, this section will assume that in the world coordinate system, the ground plane is located on the x-axis and the y-axis. This assumption simplifies aspects of the explanation here. Where this assumption is not taken or does not apply, the same methodology would be applicable with appropriate rotations and translations. For the ground plane thus defined, the distribution for the ground plane may be represented as a degenerate multivariate distribution.

The precision matrix of the distribution is a diagonal matrix in which the values of the x and y axis are equal to zero. The value in the z-axis may be set according to the certainty of the location of the ground plane in the world coordinate system. If the extrinsic camera function is known for one or more contributing sensors with a high level of confidence and the terrain is generally flat, then the position of the ground plane is presumed to be known with a similarly high degree of confidence and the value of the diagonal of the precision matrix in the z-axis may be set with a high value representing this high degree of confidence. If the position of the ground plane is known with less confidence—e.g. because of uncertainty in the position and pose of sensors or uneven terrain-then the value of the diagonal of the precision matrix in the z-axis may be set with a value representative of this lower degree of confidence.

Another example of applicable prior information is the shapes and sizes of common vehicles. For example, the size of many sedan vehicles may be known. If a detection system is able to identify a model of vehicle or a type of vehicle, this can inform the expected size of the vehicle. If the detection system successfully estimates the size of a vehicle, whether by transforming 2D variational hypotheses or estimating 3D variational hypotheses, then a multi-modal (or uni-modal) multi-variate normal distribution kernel can be constructed. The precision matrix can be expanded to be equal to the state space dimension and then fusion can be performed using product of Gaussian distributions. For example if the network provides a variational hypothesis with a probability of 20% for an object being a sedan, and 80% for the object being a truck and 0% for all remaining classes, the network can perform fusion with respect to each class by constructing a normal distribution for the category based on the prior information and fusing the variational hypothesis with respect to that category.

Vehicle size may be applied to determine the depth of the object. As an example the distribution of the depth of the object can be derived from the size of a bounding box, the size of the vehicle in based on prior information and the camera intrinsic parameters. The information regarding vehicle depth may be applied by expansion of the state space for a 2D variational hypothesis and fusion with a distribution representative of the prior information.

Other information can be incorporated into variational hypotheses using this framework. For example, if GPS information of vehicles is available, the location information taken from the GPS data and converted into a common coordinate space can be fused to a corresponding variational hypothesis. For example, in a circumstance where a cooperative perception system 10 comprises multiple cars each with one or more sensors on a road and one or more of the cars incorporates a GPS system, then the GPS information of each car can be fused into variational hypotheses calculated from the sensors. For example, to account for the GPS information the network could construct for each car a degenerate multivariate normal distribution and a precision matrix as previously described for the case of the ground truth. The precision matrix may initially be constructed as a 2D normal distribution indicating the GPS information (location of the vehicle with respect to the common coordinate system) and then accordingly expanded as previously explained with zero in the entries for additional added dimensions. The result may be treated as a variational hypothesis. The categorical distribution component may comprise a probability mass function (PMF) with value 1 for the known class of the object and zero for all other classes.

### Example Applications of Cooperative Perception Systems

The variational hypotheses of a cooperative perception system 10 as described are generally usable to direct actions of apparatus to interact with objects in the scene. In various embodiments, the cooperative perception system 10 comprises a plurality of sensors mounted on one or more vehicles and fixed structures.

In the example case illustrated in FIG. 1, a first vehicle 18A comprises two sensors 12A and 12B, while a second vehicle 18B comprises a sensor 12C, and a fixed pole 20 comprises a sensor 12D. As previously described, the sensors 12 can be multi-modal (i.e. the sensors 12 can have different types and different forms of image outputs). A processor 16 uses the output of ML systems 14 to direct actions of objects in the scene. In these embodiments, this could comprise processing the variational hypotheses as identifying objects in the world coordinate system and then directing one or more of the vehicles to adjust a course while driving based on the observed objects. In FIG. 1, processor 16 might, for example, take the fused variational hypotheses and determine that there is a pedestrian crossing a road in front of the car and either stop the vehicle or turn the vehicle to avoid the pedestrian.

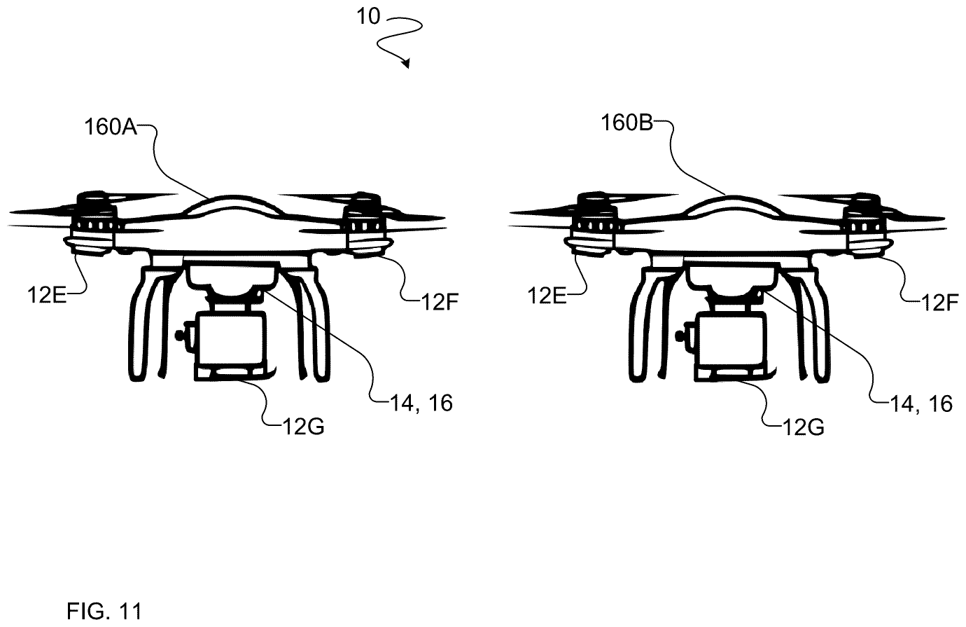

Cooperative perception system 10 can be used in various applications within the field of autonomous vehicles but can also be applied in other areas such as other vehicle types and general applications of robotics. For example two or more drones 160 as illustrated in FIG. 11 may be controlled by a system as described herein. Each drone 160 utilizes three sensors 12 with two modalities. Sensors 12E and 12F are wide-angle RGB cameras. Sensor 12G is a LIDAR sensor. The outputs of these three sensors are received by the ML system 14 and processed to produce fused variational hypotheses that are processed by processor 16 to govern the flight of the drone 30. Additional drones 30 can also coordinate within the cooperative perception system 10, each drone 30 can be equipped with one or more sensors 12.

In a further example application of a cooperative perception system 10, a plurality of fixed sensors 12 view an industrial space. The plurality of fixed sensors 12 are connected to transmit output images to ML systems 14 which prepare fused hypotheses through one of feature-kernel sharing and fusion or fusion of output variational hypotheses. The fused variational hypotheses are received by processor 16 which identifies that a hazardous incident has occurred or is occurring in the industrial space based on the objects detected and the locations of the objects in the coordinate system. This might comprise, for example, a fluid-spill or the detection of a person in an off-limits area. The processor 16 can cause the triggering of an appropriate alarm by e.g. sending a signal to an alarm system in the industrial space.

### Implementation

The ML systems 14 and processors 16 of a cooperative perception system 10 can present on a combined hardware element. For example, for some embodiments, an ML system 14 and processor 16 can be implemented with a single paired CPU and GPU in a common computational structure.

The present technology may also be implemented in the form of a program product that contains software instructions which, when executed, cause a data processor to perform a method as described herein. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

### Interpretation

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Unless the context clearly requires otherwise, throughout the description and the
comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.
Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.
Certain numerical values described herein are preceded by “about”. In this context, “about” provides literal support for the exact numerical value that it precedes, as well as all other numerical values that are near to or approximately equal to that numerical value. A particular numerical value is included in “about” a specifically recited numerical value where the particular numerical value provides the substantial equivalent of the specifically recited numerical value in the context in which the specifically recited numerical value is presented.
Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.
As will be apparent to those of skill in the art upon reading this disclosure, each of the individual embodiments described and illustrated herein has discrete components and features which may be readily separated from or combined with the features of any other described embodiment(s) without departing from the scope of the present invention.
Any aspects or features described above in reference to apparatus may also apply to methods and vice versa.
As will be apparent to those of skill in the art upon reading this disclosure, each of the individual embodiments described and illustrated herein has discrete components and features which may be readily separated from or combined with the features of any other described embodiment(s) without departing from the scope of the present invention.
Any aspects described above in reference to apparatus may also apply to methods and vice versa.
Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.
Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.
It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A cooperative perception system comprising:
a plurality of imaging sensors each of the imaging sensors connected to provide output images to one of one or more machine learning (ML) systems, the one or more ML systems trained to process the output images to yield hypotheses, each of the hypotheses comprising: one or more objects and, for each of the objects, values for each of a plurality of regressed parameters and variation data indicating uncertainty of the value for each of the plurality of regressed parameters; and
a processor connected to receive the hypotheses produced by the ML systems and to fuse the hypotheses using the variation data to yield a fused hypothesis.

2-3. (canceled)

4. The cooperative perception system according to claim 1 wherein each of the one or more ML systems is configured to output a precision matrix or covariance matrix that includes the variation data.

5. (canceled)

6. The cooperative perception system according to claim 1 wherein the ML systems are configured to classify the one or more objects into each of a plurality of classes and to output the values for each of a plurality of regressed parameters and variation data for each of the plurality of classes for each of the one or more objects.

7. The cooperative perception system according to claim 1 wherein the variation data comprises an independent-component precision matrix and an associated rotation angle.

8. The cooperative perception system according to claim 7 wherein the processor is configured to apply a rotation transformation based on the rotation angle to the independent-component precision matrix to yield a precision matrix in which off-diagonal terms indicate strengths and signs of correlations among the regressed parameter values.

9-11. (canceled)

12. The cooperative perception system according to claim 1 wherein, the variation data comprises a multivariate probability distribution and, in fusing the hypotheses, the processor is configured to compute products of the multivariate probability distributions of the hypotheses.

13. The cooperative perception system according to claim 1 wherein the one or more ML system is trained to, for each of the objects, output a likelihood that the object belongs to each of a plurality of classes.

14. The cooperative perception system according to claim 1 wherein the output images include a first set of one or more of the output images that are 2D images and a second set of the output images that are volumetric images.

15. The cooperative perception system according to claim 14 wherein the ML systems connected to receive the first set of the output images comprise a depth channel and the regressed parameters include a depth estimate output by the depth channel.

16. (canceled)

17. The cooperative perception system according to claim 1 wherein the regressed parameters for the one or more objects comprise localization parameters that estimate a position of the object and one or more object size parameters that estimate a size of the object.

18. (canceled)

19. The cooperative perception system according to claim 1 wherein the regressed parameters of the one or more objects comprise one or more object size parameters that estimate size of the object in two or more dimensions.

20. The cooperative perception system according to claim 1 wherein the processor is configured to filter the hypotheses to remove any of the hypotheses that have a confidence value below a confidence threshold before fusing the hypotheses.

21. (canceled)

22. The cooperative perception system according to claim 1 wherein the processor is configured to cluster the hypotheses, the clustering comprising:
calculate an entropy for each of the hypotheses;
select a hypothesis for which the entropy is lowest;
compute a divergence value between the selected hypothesis and the remaining hypotheses;
selecting for fusion the selected hypothesis and those of the remaining hypotheses for which the divergence value is lower than a divergence threshold.

23-24. (canceled)

25. The cooperative perception system according to claim 1 wherein a first variational hypothesis and a second variational hypothesis are derived from two-dimensional sensors and wherein the processor is configured to fuse the first variational hypothesis and the second variational hypothesis by:
projecting two or more 2D variational hypotheses into common 3D world coordinates;
identifying a point of closest approach;
estimating a piecewise conical approximation of each of the 2D variational hypotheses at a depth of the point of closest approach; and
fusing the piecewise conical approximation of the 2D variational hypotheses.

26. A cooperative perception system comprising:
a plurality of imaging sensors each of the imaging sensors connected to provide output images to one of one or more first machine learning (ML) systems, the one or more ML systems comprising a plurality of layers and trained to process the output images to yield hypotheses, each of the hypotheses comprising: one or more objects and, for each of the objects, values for each of a plurality of regressed parameters and variation data indicating uncertainty of the value for each of the plurality of regressed parameters; and
one or more processors connected to:
receive feature maps from intermediate layers of the ML systems, the feature maps comprising partially-processed image data of the plurality of imaging sensors; and
fuse the feature maps to yield a fused feature map; and
process the fused feature map to yield a refined hypothesis, the refined hypotheses comprising: one or more objects and, for each of the objects, values for each of a plurality of regressed parameters.

27. The cooperative perception system according to claim 26 wherein the feature maps each comprise a plurality of feature kernels, each of the feature kernels associated with a location and comprising a plurality of channels, each of the channels comprising a value.

28. (canceled)

29. The cooperative perception system according to 26 wherein the one or more processors comprises a second ML system configured to receive the fused feature map as input and to output the refined hypothesis.

30. The cooperative perception system according to any of claims 26 to 29 wherein the fused feature map comprises one or more feature tensors, the one or more processors are configured to populate one or more feature tensors with values from one or more sets of fused feature maps and the second ML system is configured to receive the one or more feature tensors as inputs and to output the refined hypothesis.

31. The cooperative perception system according to claim 26 wherein the sensors comprise a set of first sensors having a first modality and a set of second sensors having a second modality, wherein the first modality is a 2D imaging modality and the second modality is a 3D imaging modality, and the one or more processors are configured to:
fuse a first set of feature maps corresponding to the first sensors,
fuse a second set of feature maps corresponding to the second sensors; and
combine the fused first and second sets of feature maps to yield the fused feature map.

32-37. (canceled)

38. The cooperative perception system according to claim 26 wherein the feature maps comprise categorical multivariate distributions.

39-40. (canceled)

41. The cooperative perception system according to claim 26 wherein the one or more processors are configured to cluster the feature maps, the clustering comprising:
calculating an entropy for each of the feature maps;
selecting a feature map for which the entropy is lowest;
computing a divergence value between the selected feature map and the remaining feature map; and
selecting for fusion the selected feature map and those of the remaining feature maps for which the divergence value is lower than a divergence threshold.

42-81. (canceled)
